(19) United States
(12) Patent Application Publication
(10) Pub. No.: US 2022/0405852 A1
(43) Pub. Date: Dec. 22, 2022

(54) System and method for tracking proof of insurance and insurance compliance

(71) Applicant: TrustLayer, Inc., Brandon, FL (US)

(72) Inventors: John FOHR, Brandon, FL (US); Vincenzo ACINAPURA, Brandon, FL (US)

(73) Assignee: TrustLayer, Inc., Brandon, FL (US)

(21) Appl. No.: 17/634,102

(22) PCT Filed: Aug. 9, 2020
(86) PCT No.: PCT/US2020/045582

§ 371 Date: Feb. 9, 2022

Related U.S. Application Data
(60) Provisional application No. 62/884,990, filed on Aug. 9, 2019.

(51) Int. Cl. G06Q 40/08; G06Q 30/00; H04L 9/32; H04L 9/00

(52) U.S. Cl. CPC G06Q 40/08; G06Q 30/018; H04L 9/3218; H04L 9/50

(57) ABSTRACT

The instant invention provides a real-time environment where the proof of insurance information is updated as the insurance status changes. It provides users with processes that benefit from a live proof or a smart certificate of insurance. It utilizes flexible storage architecture so that users can leverage both distributed ledger technology as well as more traditional storage methods to provide real time secure storage and retrieval of certificate of insurance information to all parties involved in a transaction.

### CROSS-REFERENCE TO RELATED APPLICATION

This application claims priority from U.S. provisional patent application No. 62/884,990, filed Aug. 9, 2019 and PCT application SN USPCT/US2020/045582, filed Aug. 9,2020 which are hereby incorporated by reference herein for all purposes.

### COPYRIGHT STATEMENT

A portion of the disclosure of this patent document contains material that is subject to copyright protection. The copyright owner has no objection to the facsimile reproduction by anyone of the patent document or the patent disclosure as it appears in the Patent and Trademark Office patent file or records, but otherwise reserves all copyright rights whatsoever.

### DESCRIPTION

### Technical Field

This invention relates generally to the field of digital certificate of insurance (COI) management.

### Background

A Certificate of Insurance (COI) is a document used to provide evidence of specific insurance coverage. The certificate provides evidence of the insurance and usually contains information on the types and limits of coverage, insurance company, policy number, named insured, and the policies' effective periods. Although the certificate should not be substituted for the information contained in the actual insurance policies, it is usually a reliable source of information or proof of insurance coverage. Certificates of Insurance (COI) are usually requested by opposite parties in an agreement, contract, or transaction to ensure that the other party has the appropriate insurance coverage. Typically, COIs include the following information: the existence of an insurance policy, summary of the key aspects and conditions of the policy, policyholder's name, policy effective date, type of coverage, policy limits, and other important details of the policy.

Without a COI, a company or contractor will have difficulty securing clients; most clients will not want to assume the risk that might be caused by the contractor or provider due to their lack of insurance. Therefore, a simple and easy means of documenting the existence of insurance coverage was needed and the COI was created to provide the proof of insurance. In addition, the insurance company has a need to be made aware of any significant changes in the insured business, and clients want to be informed of any interruptions in the insured coverage. Additionally, financial institutions also have a need to verify insurance to protect loans and other financial transactions. The insurance company, insured, clients and regulators and financial institutions, are the typical entities who have a vested interest in the COI's and that interest requires that they have access to accurate and up to date documentation of insurance policy coverage.

In most cases, COI's are static documents. Typically, the COI does not change after the COI is printed. This means that the COI is not updated even if there is a legal amendment/modification to the underlying insurance policy or the insured does not pay the required premium. Accordingly, under existing technology and practices, the COI serves as a static document that records the existence of an insurance policy as of the date the COI is created. Traditional paper-based or computer-based representations of paper-based COI's (e.g. PDFs) are static, text-based documents. Therefore, if there is a change in the status of the COI such as the business of the insured changes, the insured does not pay the premium or the insurance company initiates a policy change, legal COIs cannot be revised or canceled and utilizing a paper-based or text-based documents do not reflect the changes in real-time.

For example: if the insured does not pay the premium due, then the policy normally is canceled after proper notification which results in the insured not having the coverage described in the COI. The client who has employed or contracted with the insured needs to be advised of the termination of the policy but with a paper-based or computer-based representation of paper-based COI's the notification process is not seamless and results in insured not having the proper insurance coverage. Furthermore, the insurance Broker might not always have updated information about the status of an insurance policy from the Carrier. Therefore, if the insured does not pay the premium and the policy is canceled, it might take weeks or months for the broker to be notified. During this time, the broker—who mistakenly believes that the insured still has insurance coverage could continue to create COIs which are not accurate.

Therefore, there is a need for a digital COI that is capable of creating a new and updated COI and a method for facilitating the formation, versioning, and management of COI's.

### BRIEF DESCRIPTION OF THE FIGURES

FIG. 1 is a schematic representation of the requester's workflow for proof of insurance;

FIG. 2 depicts an exemplary flow of an exemplary distributed ledger technology workflow insurance verification;

FIG. 3 depicts a dashboard that allows the active parties to view compliance status;

FIG. 4 depicts the embodiment of the invention distributed ledger technology workflow;

FIG. 5 depicts the network chart sheet of the embodiment of the invention;

FIG. 6 depicts the document processing flow of the embodiment of the invention; and

FIG. 7 depicts the Digital Ledger Technology Infrastructure of the embodiment of the invention.

FIG. 8 Compliance module dashboard overview.

FIG. 9 Compliance module active party dashboard.

FIG. 10 Compliance module organization parties dashboard.

FIG. 11 Compliance module detail dashboard.

FIG. 12 Compliance module evidence of insurance dashboard.

FIG. 13 Compliance module compliant and expiring requirements form.

### DETAILED DESCRIPTION

The terms Corda, Corda Distributed Ledger Technology, Distributed Ledger Technology and Blockchain are used interchangeably to mean Distributed Ledger Technology.

The terms instant invention, platform, embodiment, and system are used interchangeably and mean the software platform of the instant invention.

The term bytecode is a program code that has been compiled from source code into low-level code designed for a software interpreter. It may be executed by a virtual machine or further compiled into machine code, which is recognized by the processor

The terms data and information as used within the specification are used interchangeably to mean information either downloaded, inputted, created, derived, or uploaded to or from the instant invention.

The following description of the embodiments of the invention is not intended to limit the invention to these embodiments but rather to enable a person skilled in the art to make and use this invention.

The Certificate of Insurance (COI) is a document used to provide information on specific insurance coverage. The COI provides verification of the insurance and usually contains information on the types and limits of coverage, insurance company, policy number, named insured, details regarding what is specifically included and excluded in a policy, and the policies' effective periods. It also refers to additional details of the insurance policy and coverage. It also may include information upon which insurance is based. The terms COI, certificate of insurance, automotive insurance proof, proof of insurance coverage, declaration page, “dec page”, are used interchangeably and mean Certificate of Insurance. The instant invention allows the information to be tracked. The information can be virtual or extracted from a piece of paper. The instant invention can track dynamic information (i.e. location of an insured item) which is then used to determine insurance coverage.

The insurance company, contracting company, insured, clients, insurance regulators, and certificate holder (the company which is requesting evidence that the insured is covered) are the entities who have a vested interest in the COI's accurately providing the insured documentation of insurance policy coverage. Regulators and service providers (lawyers, consultants, accountants, and claims adjusters) are some other parties who might also need access.

The industry needs a system that provides real-time proof that the underlying insurance is compliant. The instant invention provides a method for facilitating the dissemination, monitoring, and validation of Certificates of Insurance (COI) and/or proof of insurance.

A certificate of insurance (COI) is a document used to provide information on specific insurance coverage. The COI provides verification of the insurance and contains information on the types and limits of coverage, insurance company, policy number, named insured, and the policies' effective periods.

Specifically, a COI is a document issued by an insurance broker that provides evidence that a company or individual (an insured) has insurance coverage. The insurance coverage details provided by the COI include what is the exact limits of the coverage, the type of coverage, who is covered, the effective date of the policy, and the types and dollar amount of limits and deductibles. The current business climate and speed of transactions require that the COI process has the capability to provide all parties with the insurance information needed in real-time. The instant invention provides real-time data for the client, customer, insurance company, contracting company, insured, clients and certificate holder or company that wants proof their client/vendor/counterparty is insured.

In most cases, you need a certificate of insurance that proves that there is the required or adequate insurance coverage prior to commencing an activity such as starting a contract, bidding on a project, purchasing and registering an automobile, purchasing a home, renting an apartment, or moving, etc.

The COI process goes further because the COI is provided to an insured's counterparty (the certificate holder) upon the insured's request, and frequently the insured's counterparty require COIs to list the insured's counterparty as the certificate holder for the COI.

A typical user of the information contained in the COI are requesters, such as, but not limited to, corporations, sole proprietors, partnerships, condo associations, small businesses, fortune 500 organizations, manufacturers, general contractors, landlords, property management companies, real estate development firms, companies or individuals procuring services and/or the creation of tangible or intangible products, nonprofit organizations, and/or any entity that requests certificates of insurance from vendors in the course of doing business.

Insureds are entities that need to provide proof of insurance such as a certificate of insurance in the normal course of doing business such as, but not limited to, construction subcontractors, professional service providers, contractors, vendors, consultants, manufacturing companies and other similar products/services types companies.

Entities which utilize the information contained in a COI include Brokers/Agents, Insurance sales and customer service representatives, Carriers, Insurance underwriters, Regulators, Government and industry associations who require oversight of insurance transactions, such as insurance commissioners, Service Providers, Attorneys, accountants, consultants, claims adjusters, risk consultants who work for one of the other parties.

The instant invention provides a real-time environment where the COI information is updated as the insurance status changes. Potential users and processes that benefit from a live proof or a smart certificate of insurance or insurance system include real-time and ongoing (live) proof of insurance, real-time and ongoing (live) proof of compliance with contract requirements, real-time and ongoing (live) data sharing and payment sharing information of insurance policy data between carriers, brokers, regulators, and other insurance counterparties, companies that hire vendors, manufacturers tracking suppliers, manufacturers tracking product supply chains, condo associations, HOAs, and other real estate associations tracking vendor insurance and/or professional licenses, landlords, property owners, property management companies, property managers tracking vendor insurance and/or professional licenses and/or proof of tenant renters' insurance, lenders identifying and needing precise insight into the most qualified and low-risk borrowers, insurance carriers requiring detailed information on potential/renewing insureds to better underwrite policies, regulators investigating insurance fraud, regulators trying to prevent worker misclassifications such as independent contractors versus employee status, carriers needing precise insured and accident information in the claims process, carriers needing a secure method to pay different parties in the claims' lifecycle.

The instant invention also enables better tracking and/or smart COIs for the surety bond workflow.

The instant invention also enables the provider of medical services to track insurance for their clients.

The instant invention also enables parametric insurance that is turned on/off/adjusted based on requirements of insured's partner/client.

One embodiment of the invention promotes tracking proof of insurance and insurance compliance to the Industries/Trades/Verticals such as restaurants, construction companies and manufacturers.

Another embodiment of the invention allows lenders to identify Borrower Risk. Lenders/Financial institutions can upload borrowers to verify that they have insurance, if/when a borrower's insurance is terminated unexpectedly and thereby mitigating the risk and providing active risk management.

Another embodiment of the invention allows “forced place” coverage to automatically be turned on or turned off. Mortgagees are required to have homeowner's insurance throughout the duration of a mortgage. If this insurance lapses, a lender will often force place additional insurance, which is often more expensive to the homeowner. If the mortgagee purchases homeowner's coverage, the invention can automatically notify the force placed insurance company to turn off the more expensive coverage.

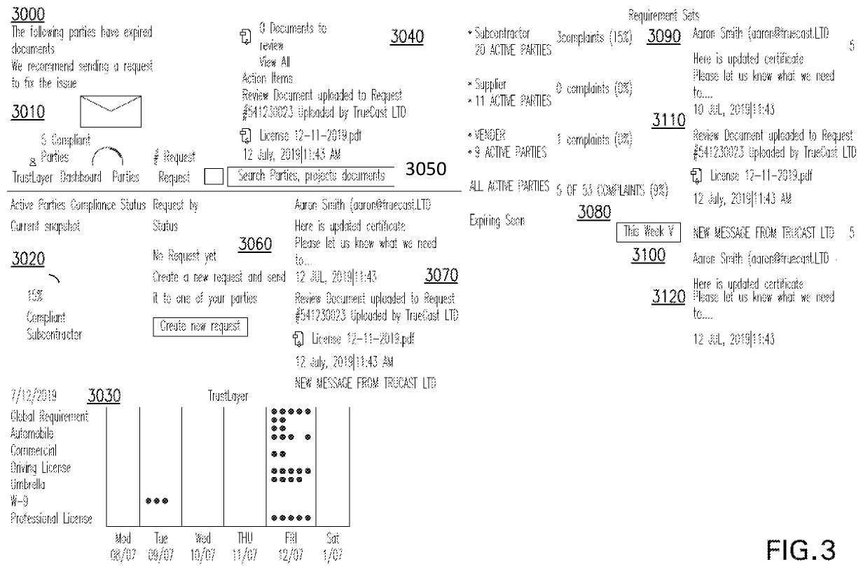

The instant invention enables the users to choose multiple ways to receive updates. Some of these include emailed updates, visibility in dashboard shown in FIG. 3 and API triggers.

The additional workflows include:

1) internal borrower ERP workflows based on non-compliance.

2) Auto-generated emails to the borrower to ask them to verify coverage, so they can become compliant again.

When the user is a lender the instant invention can be configured to automatically notified them of changes and additional workflows can be automatically triggered so the lender can follow up to with the borrower so that problems are identified early and can be resolved. An example of this proactive approach enabled by the real-time reporting of the instant invention is if a company cancels their insurance, the lender can contact them to discuss why the policy has been canceled. This is an important benefit of real-time COI process because canceling insurance is a leading indicator that a company is having financial difficulty.

The real-time COI process as enabled by the instant invention also provides equipment leasing insurance verification, automotive insurance verification and mortgage/home insurance verification.

Another example where the instant invention real-time COI is beneficial is during the home purchase process. The instant invention allows the homebuyer a more efficient way to share their insurance information with the parties involved in the home closing.

Traditionally during the home purchase process, the buyer needs proof of insurance to get mortgage approval. The instant invention is capable of updating a COI in real-time if any of the parameters captured by the instant invention change thereby ensuring that an updated COI is available at closing. Previous to the instant invention the process was highly depended on phone calls and emails to get the right person at the insurance company to send the correct information to the bank. The instant invention can also benefit the insurance company. If the insurance company performs an audit on the house or property which is being purchased and determines that there is a premium change for the policy, then the insurance company can update the COI in real-time and notify the buyer of the premium change.

The instant invention provides the insureds the convenience of having all business documents in one secure place ready to share with requestors. In addition, the instant invention provides the ability to quickly procure insurance products from trusted sources, the ability to prove insurance at any time in a trusted manner, the ability to connect with trusted service buyers/procurers.

The instant invention provides the brokers/agents the ability to provided insureds on-demand proof of insurance tools and it provides an efficient way to collect data from the insured to expedite the underwriting process for new customers including the on-boarding and the renewal process.

The instant invention allows brokers a real-time method to produce COIs.

The instant invention allows carriers a real-time method to initiate and collect information for policy renewal. Underwriters can automatically send forms to Insureds at renewal time to ask them for additional information prior to renewal.

The instant invention provides the carriers/brokers a means to conduct real-time auditing. Specifically, the instant invention allows the carriers/brokers access to real-time metrics for COIs issued and details of the certificate holders so as to identify new risks for an insured therefore mitigating risk and providing risk management. For example, if a painting company said it has only 3 staff, but issues 100 COIs, this might suggest the painting company has a larger business than what was used to estimate their policy. Another example, is if a residential painting company said it does not work on bridges, if a COI certificate holder name has the word “bridge” in it, then the Carrier/Broker is automatically notified so that he can offer the insured the correct insurance.

For example, carriers would have ongoing insight into the Certificate Holders (i.e. clients) of the Insured. The carrier dashboard of the instant invention will provide metrics on the Certificate holders. This will help the carrier have greater insight into the risk associated with the certificate holders and provide risk management.

Another risk management benefit of real-time COI's of the instant invention is that the carrier will also be able to verify that all of the Insured's subcontractors have coverage. For example, if the carrier ensures a Homebuilder, they have less risk if all of the Subcontractors have insurance.

The instant invention provides the regulators such as government and industry associations that require oversight of insurance transactions real-time information which can be used to determine insurance premium fraud prevention, workers' comp fraud prevention.

The instant invention enables workflows such as downstream requests which are requests for proof of insurance/certification from a third party, contract details requirements for insurance coverage (and other certifications), evidence of coverage from the counterparty.

Once the instant invention has received the manual or automated upload of information the automation of the instant invention is capable of extracting the information and configuring the COI and the invention automatically verifies compliance and compares the information against insurance requirements.

The instant invention is also capable of data extraction and comparison for insurance requirements and automated workflows commence to verify the provided insurance information with the broker.

When the instant invention identifies policy expiration dates they can be tracked and send notifications to insureds, brokers, and/or requesters when expirations are nearing and begin the workflow to automate acquisition of the new insurance documents to prove/maintain compliance with the requirements set forth in the aforementioned contract.

When the instant invention identifies that the COI does not meet Customer's requirements, the instant invention marks the vendor as noncompliant and begin automated compliance workflows to acquire a compliant COI with the requisite insurance requirements.

The following information and procedures are used by the instant invention:

a. Insurance requirements are provided by the customer which are used by the instant invention to verify respective vendor Certificates of Insurance (“COI”) for insurance compliance.

b. Vendor information/document transfer is enabled by the instant invention.

Vendor onboarding workflow: Using the instant invention the customer can add a new Party to a workflow and request and/or upload new vendor documents such as COIs, w9 and state trade licenses, etc.

Verification workflows: The instant invention has automation that extracts COI data and compares it to insurance requirements which are inputted by the customer for respective vendors.

Compliant Workflow: If the COI meets customer's requirements as inputted into the instant invention, the vendor is marked as compliant and the customer is notified of renewal status and/or send out renewal notifications to vendor beginning 45 days prior to the stated policy expiration date(s).

Noncompliant Workflow: If the COI does not meet customer's requirements as inputted into the instant invention, the invention instant will mark the vendor as noncompliant and begin automated compliance workflows to acquire a compliant COI with the requisite insurance requirements.

Once the vendor or vendor's broker uploads an updated COI the instant invention will process the vendor's insurance policies against the insurance requirements inputter by the customer and mark it as compliant or noncompliant which triggers the respective workflows.

Compliance reporting/notifications, the instant invention allows the customer to view vendor compliance status via dashboards of the instant invention.

The instant invention can also notify the customer of renewal statuses of vendors beginning 45 days prior to the stated policy expiration date(s).

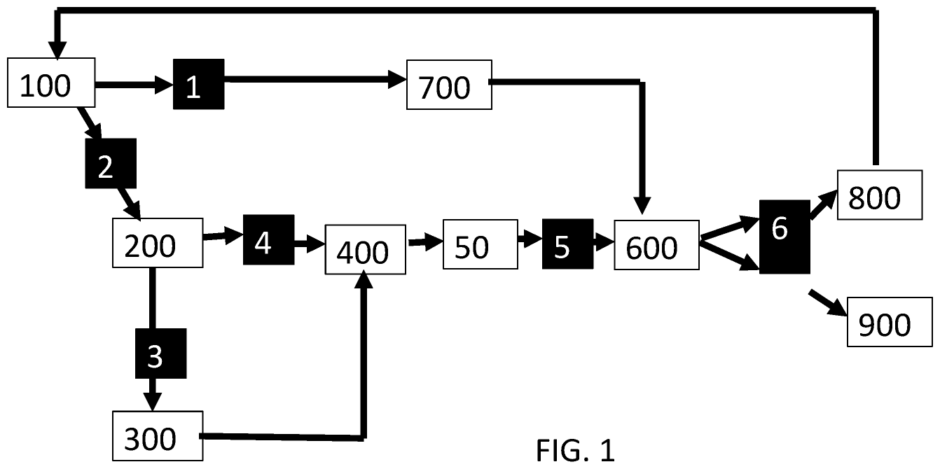

Referring to FIG. 1-7 and more specifically to FIG. 1 which provides a schematic of the proof of insurance workflow of an embodiment of the invention.

Step 1. Requester 100 creates insurance requirements.

Step 2. Requester request COI from insured 200.

Step 3. Insured 200 delegates task to broker 300

Step 4. Insured or broker uploads COI 400 to an embodiment of the invention.

Step 4. COI data 500 is extracted and compared to requirements 600.

Step 6. Insured marked as Compliant 900 or Non-Compliant 800.

Step 7. Non-compliant request is marked as non-compliant, noncompliant notifications are sent out and COI request workflow begins again.

Step 8. Compliant request is marked as compliant, compliance notifications are sent out, expiration dates tracked for next compliance request actions.

The instant invention provides proof of insurance/certification to a third party, sends insureds automated requests for missing or expiring certificates, reducing time spent manually monitoring COIs, creates and sends the insureds emails and links to upload their certifications.

The instant invention provides insureds and producers the ability to easily submit their certificates and other documents.

The instant invention provides the users a feature and functionality rich platform.

As shown in FIG. 1 the instant invention provides features/functionality such as real-time synchronization of broker/agent and insurance carrier systems which reduce the cost of servicing and providing COI and supporting documents.

The instant invention allows carriers and brokers share policy and additional customer data on a real-time basis using Corda Distributed Ledger Technology (Blockchain). This allows the broker and/or carrier to automate insurance verification as well as have additional workflows dependent on this policy information because they will both have a single source for the information and they have access to the document data at the time of entry.

The instant invention extracts the insurance requirements from a contract which has been uploaded.

Then the system then initiates the verification of the insurance using the following:

a) distributed ledger application on Corda;

b) API; or,

c) someone uploading a Certificate of Insurance. If someone uploads a COI, the system may attempt to verify if the broker/carrier is in the network and attempt to verify that the coverage is still in place.

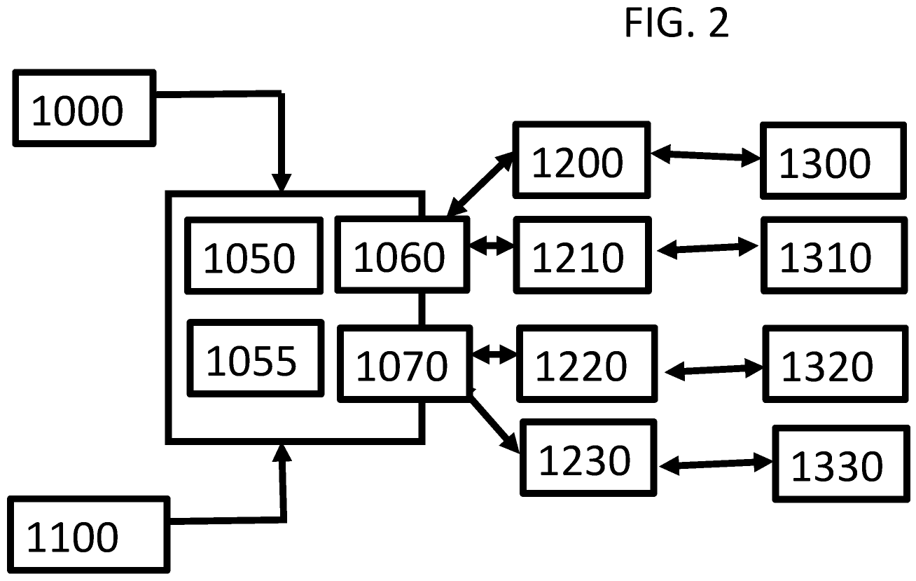

FIG. 2 provides a schematic of the real-time automated Insurance verification workflow using a distributed ledger technology.

Contract 1000 and COI 1100 are uploaded to the system 1050 and the system 1050 creates and stores the digital proof of Insurance 1055 in the distributed ledger technology. The COL 1060 policy 1070 is received and stored in the distributed ledger technology and/or Corda distributed Ledger from underwriters 1300, 1310, 1320 and 1330 who upload policy information 1200, 1210, 1220 and 1230.

The instant invention provides a Passport that provides the following features:

a. Profile page, similar to a Yelp page from which a client can request a COI or other documents. Documents, or insurance information, or other certificates can be visible (public, visible to logged in and authenticated users, or available upon request).

b. Certificate of Insurance in Apple Wallet and Android Passes: Once the subcontractor uploads a certificate and this is verified, they can be prompted to add this certificate to their phone.
Google Passes API: https://developers.google.com/pay/passes/, Google pay for passes. The Google Passes API facilitates customers saving boarding passes, loyalty programs, offers, gift cards, or tickets to their phones for easy access at the right time, and engage them through location-based notifications, real-time updates, and more.

Apple Wallet API: https://developer.apple.com/wallet/. Apple wallet gives users a convenient way to organize and use rewards cards, boarding passes, tickets, and gift cards. You can bring up passes in your app with PassKit APIs, send them via email, or post them on the web. You can also set the time or location for an item to appear.

By using google play and apple wallet passes, an embodiment of the invention facilitates the consumer experience provided by CSIO, My Proof of Insurance. https://www.csio.com/video/my-proof-insurance-%E2%80%93-consumer-experience

The The instant invention provides COI Website Tools for Brokers.

The instant invention using the COI system Request JavaScript Widget on Broker Website. The Broker can add a widget onto the website to allow the user to easily initiate COI request.

The system may offer brokers a white-labeled site that helps my clients track insurance and documents.

The instant invention provides real-time monitoring of Shared Folders.

An embodiment of the invention can monitor a folder, extract structured data from insurance documents placed in the folder, and identify conflicts in the documents. For example, if two documents both have the same policy number but have different expiration dates, this information would be flagged to the user. This is similar to applications used by Box.com®, Dropbox®, Google® drive, Microsoft® Sharepoint®, and/or other on-premise or cloud folder.

The instant invention provides verifying and tracking other compliance documentation.

The instant invention provides verifying and tracking professional licenses and certificates; relevant government documents (i.e., w9); and bond/surety information when applicable.

Professional Licenses system has a similar workflow, but instead of working with Carriers/Brokers, the “certifier” is another third party (or government agency).

Since most license data is public and available by searching the various license databases the instant invention can is looked up the data on the specific database to verify a license and that it is current. For example all Florida Professional Engineers license information can be found at https://fpbe.org/licensure/licensee-search/ which is searchable by the instant invention and it can use the data to populate the information in the. The instant invention also contains evidence of Insurance by Type/Subject, Attribute, Type, Attribute ID, and Document/Source as well as evidence of IRS forms

An embodiment of the instant invention can handle a multitude of IRS and government forms. Typical IRS documentation includes W9, TIN (tax id forms) as well as state, county, city, legal forms, and licenses. The instant invention is also able to assist with trade association and university, school, and union credentialing verification.

The instant invention provides the users a technology rich platform.

At the core of the instant invention is the data which it stores in the various information. This data is structured to replicate the Acord data schema and is configurable to store other information including but not limited to license, tax, and loan data.

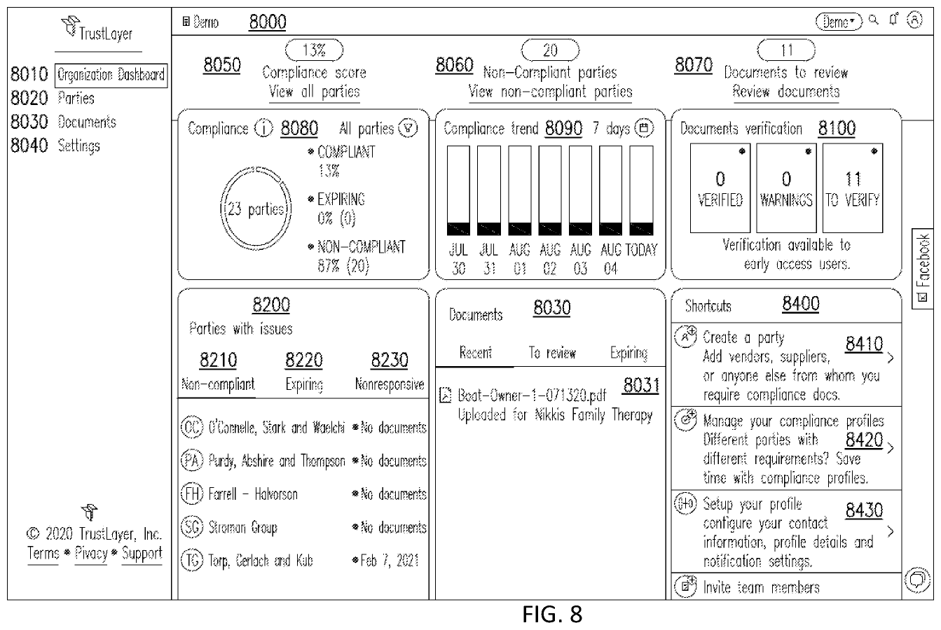

Referring to the Acord Schema: which is regularly updated, and the instant invention provides for real-time updates to the data as a result to changes to the schema by the creation of updateable tables and data structures in the instant invention. The following is a representative schema shown in FIG. 8.

The ACORD 25 (2016/03)—Certificate of Liability Insurance is the document which is issued is an information only document and confers no rights upon the certificate holder. The certificate does not affirmatively or negatively amend, extend, or alter the coverage afforded by the policies listed on the certificate. However, it does show that the insured has the listed coverages as of the date that the COI was produced.

The purpose of the certificate is to provide information to an interested third-party regarding insurance that is in force at the time of certificate issuance. Although many companies provide notice of cancellation to certificate holders, they are not obligated to do so unless such requirement is set forth in the policy itself directly or by endorsement to the policy.

The instant invention captures the following information which is mapped to the Acord Certificate of Liability which can be found in Table 1:

TABLE 1
Acord Certificate of Liability mapping

| Section Name | Field Name | Description |
|---|---|---|
| IDENTIFICATION | Date | Enter date: The date on which the form |
| SECTION | | is completed. (MM/DD/YYYY) |
| IDENTIFICATION | Producer | Enter text: The full name of the |
| SECTION | | producer/agency. |
| IDENTIFICATION | | Enter text: The mailing address line |
| SECTION | | one of the producer/agencies. |
| IDENTIFICATION | | Enter text: The mailing address line |
| SECTION | | two of the producer/agency. |
| IDENTIFICATION | | Enter text: The mailing address city |
| SECTION | | name of the producer/agency. |
| IDENTIFICATION | | Enter code: The mailing address state |
| SECTION | | or province code of the producer/ |
| | | agency. |
| IDENTIFICATION | | Enter code: The mailing address postal |
| SECTION | | code of the producer/agency. |
| IDENTIFICATION | Contact Name | Enter text: The name of the individual |
| SECTION | | at the producer's establishment that is |
| | | the primary contact. |
| IDENTIFICATION | Phone (A/C, | Enter number: The producer's contact |
| SECTION | No, Ext) | person's phone number. If applicable, |
| | | include the area code and extension. |
| IDENTIFICATION | Fax No. (A/C, | Enter number: The fax number of the |
| SECTION | No, Ext) | producer/agency. |
| IDENTIFICATION | Email Address | Enter text: The producer's contact |
| SECTION | | person's email address. |
| IDENTIFICATION | Insured | Enter text: The named insured(s) as it/ |
| SECTION | | they will appear on the policy |
| | | declarations page. |
| IDENTIFICATION | | Enter text: The named insured's |
| SECTION | | mailing address line one. |
| IDENTIFICATION | | Enter text: The named insured's |
| SECTION | | mailing address line two. |
| IDENTIFICATION | | Enter text: The named insured's |
| SECTION | | mailing address city name. |
| IDENTIFICATION | | Enter code: The named insured's |
| SECTION | | mailing address state or province |
| | | code. |
| IDENTIFICATION | | Enter code: The named insured's |
| SECTION | | mailing address postal code. |
| INSURERS | Insurer A | Enter text: The insurer's full legal |
| AFFORDING | | company name(s) as found in the file |
| COVERAGE | | copy of the policy. Use the actual |
| | | name of the company within the group |
| | | to which the policy has been issued. |
| | | This is not the insurer's group name or |
| | | trade name. As used here, this is |
| | | Insurer A. |
| INSURERS | NAIC # | Enter code: The identification code |
| AFFORDING | | assigned to the insurer by the |
| COVERAGE | | National Association of Insurance |
| | | Commissioners (NAIC). As used here, |
| | | this is Insurer A. |
| INSURERS | Insurer B | Enter text: The insurer's full legal |
| AFFORDING | | company name(s) as found in the file |
| COVERAGE | | copy of the policy. Use the actual |
| | | name of the company within the group |
| | | to which the policy has been issued. |
| | | This is not the insurer's group name or |
| | | trade name. As used here, this is |
| | | Insurer B. |
| INSURERS | NAIC # | Enter code: The identification code |
| AFFORDING | | assigned to the insurer by the |
| COVERAGE | | National Association of Insurance |
| | | Commissioners (NAIC). As used here, |
| | | this is Insurer B. |
| INSURERS | Insurer C | Enter text: The insurer's full legal |
| AFFORDING | | company name(s) as found in the file |
| COVERAGE | | copy of the policy. Use the actual |
| | | name of the company within the group |
| | | to which the policy has been issued. |
| | | This is not the insurer's group name or |
| | | trade name. As used here, this is |
| | | Insurer C. |
| INSURERS | NAIC # | Enter code: The identification code |
| AFFORDING | | assigned to the insurer by the |
| COVERAGE | | National Association of Insurance |
| | | Commissioners (NAIC). As used here, |
| | | this is Insurer C. |
| INSURERS | Insurer D | Enter text: The insurer's full legal |
| AFFORDING | | company name(s) as found in the file |
| COVERAGE | | copy of the policy. Use the actual |
| | | name of the company within the group |
| | | to which the policy has been issued. |
| | | This is not the insurer's group name or |
| | | trade name. As used here, this is |
| | | Insurer D. |
| INSURERS | NAIC # | Enter code: The identification code |
| AFFORDING | | assigned to the insurer by the |
| COVERAGE | | National Association of Insurance |
| | | Commissioners (NAIC). As used here, |
| | | this is Insurer D. |
| INSURERS | Insurer E | Enter text: The insurer's full legal |
| AFFORDING | | company name(s) as found in the file |
| COVERAGE | | copy of the policy. Use the actual |
| | | name of the company within the group |
| | | to which the policy has been issued. |
| | | This is not the insurer's group name or |
| | | trade name. As used here, this is |
| | | Insurer E. |
| INSURERS | NAIC # | Enter code: The identification code |
| AFFORDING | | assigned to the insurer by the |
| COVERAGE | | National Association of Insurance |
| | | Commissioners (NAIC). As used here, |
| | | this is Insurer E. |
| INSURERS | Insurer F | Enter text: The insurer's full legal |
| AFFORDING | | company name(s) as found in the file |
| COVERAGE | | copy of the policy. Use the actual |
| | | name of the company within the group |
| | | to which the policy has been issued. |
| | | This is not the insurer's group name or |
| | | trade name. As used here, this is |
| | | Insurer F. |
| INSURERS | NAIC # | Enter code: The identification code |
| AFFORDING | | assigned to the insurer by the |
| COVERAGE | | National Association of Insurance |
| | | Commissioners (NAIC). As used here, |
| | | this is Insurer F. |
| COVERAGE | Certificate | Enter identifier: The producer assigned |
| INFORMATION | Number | number for the certificate. |
| COVERAGES | Revision | Enter number: The producer assigned |
| | Number | revision number for the certificate. |
| COVERAGE | Insr Ltr | Enter code: The Company Letter of the |
| INFORMATION | | insurer, as identified in the “Insurer(s) |
| | | Affording Coverage” form section, |
| | | associated with the general liability |
| | | policy. |
| COVERAGE | Commercial | Check the box (if applicable): Indicates |
| INFORMATION | General Liability | the claims made or occurrence option |
| | | applies for the general liability policy. |
| COVERAGE | Other General | Check the box (if applicable): Indicates |
| INFORMATION | Liability | the “claims made” option applies on |
| | Coverages - | the general liability policy. |
| | Claims-Made | |
| COVERAGE | Occur | Check the box (if applicable): Indicates |
| INFORMATION | | the general liability policy, occurrence |
| | | basis applies. |
| COVERAGE | Check Box | Check the box (if applicable): Indicates |
| INFORMATION | | other coverage not found on the form |
| | | exists for the general liability policy. |
| COVERAGE | Field Box | Enter text: The description of other |
| INFORMATION | | coverage (not the limit) on the general |
| | | liability policy. Any questions about |
| | | appropriate limits or applicable policy |
| | | coverage(s) should be answered by |
| | | the issuing insurer(s). |
| COVERAGE | Check Box | Check the box (if applicable): Indicates |
| INFORMATION | | other coverage not found on the form |
| | | exists for the general liability policy. |
| COVERAGE | Field Box | Enter text: The description of other |
| INFORMATION | | coverage (not the limit) on the general |
| | | liability policy. Any questions about |
| | | appropriate limits or applicable policy |
| | | coverage(s) should be answered by |
| | | the issuing insurer(s). |
| COVERAGE | General Aggregate | Check the box (if applicable): Indicates |
| INFORMATION | Limit Applies | the general liability policy, general |
| | Per: - Policy | aggregate limit applies per policy. |
| COVERAGE | Project | Check the box (if applicable): Indicates |
| INFORMATION | | the general liability policy, general |
| | | aggregate limit applies per project. |
| COVERAGE | Loc | Check the box (if applicable): Indicates |
| INFORMATION | | the general liability policy, general |
| | | aggregate limit applies per location. |
| COVERAGE | Other | Check the box (if applicable): Indicates |
| INFORMATION | checkbox | the general liability policy, general |
| | | aggregate limit applies to option is |
| | | other than those listed on the form. |
| COVERAGE | Other | Enter text: The description of the other |
| INFORMATION | Description | option to which the general liability |
| | | policy, general aggregate limit applies. |
| COVERAGE | Addl Insured | Enter Y for a “Yes” response. Input N |
| INFORMATION | | for “No” response. Indicates if the |
| | | certificate holder has been named as |
| | | an additional insured on the general |
| | | liability policy. |
| COVERAGE | Subr Wvd | Enter Y for a “Yes” response. Input N |
| INFORMATION | | for “No” response. Indicates if |
| | | subrogation has been waived on the |
| | | general liability policy. |
| COVERAGE | Policy Number | Enter identifier: The identifier assigned |
| INFORMATION | | by the insurer to the general liability |
| | | policy, or submission, being |
| | | referenced exactly as it appears on |
| | | the policy, including prefix and suffix |
| | | symbols. If required for self-insurance, |
| | | the self-insured license or contract |
| | | number. |
| COVERAGE | Policy Eff | Enter date: The effective date of the |
| INFORMATION | (MM/DD/YYYY) | general liability policy. The date that |
| | | the terms and conditions of the policy |
| | | commence. |
| COVERAGE | Policy Exp | Enter date: The date on which the |
| INFORMATION | (MM/DD/YYYY) | terms and conditions of the general |
| | | liability policy will expire. |
| COVERAGE | Limits - Each | Enter limit: The general liability, each |
| INFORMATION | Occurrence $ | occurrence limit amount. Any |
| | | questions about appropriate limits or |
| | | applicable policy coverage(s) should |
| | | be answered by the issuing insurer(s). |
| | | As used here, the limit should be |
| | | listed as a whole dollar amount, as |
| | | governed by the policy. |
| COVERAGE | Damage to | Enter limit: The general liability, |
| INFORMATION | Rented Premises $ | damage to rented premises each |
| | | occurrence limit amount. Any |
| | | questions about appropriate limits or |
| | | applicable policy coverage(s) should |
| | | be answered by the issuing insurer(s). |
| | | As used here, the limit should be |
| | | listed as a whole dollar amount, as |
| | | governed by the policy. |
| COVERAGE | Med Exp $ | Enter limit: The general liability, |
| INFORMATION | | medical expense each person limit |
| | | amount. Any questions about |
| | | appropriate limits or applicable policy |
| | | coverage(s) should be answered by |
| | | the issuing insurer(s). As used here, |
| | | the limit should be listed as a whole |
| | | dollar amount, as governed by the |
| | | policy. |
| COVERAGE | Personal & Adv | Enter limit: The general liability, |
| INFORMATION | Injury | personal and advertising injury limit |
| | | amount. Any questions about |
| | | appropriate limits or applicable policy |
| | | coverage(s) should be answered by |
| | | the issuing insurer(s). As used here, |
| | | the limit should be listed as a whole |
| | | dollar amount, as governed by the |
| | | policy. |
| COVERAGE | General | Enter limit: The general liability, |
| INFORMATION | Aggregate $ | general aggregate limit amount. Any |
| | | questions about appropriate limits or |
| | | applicable policy coverage(s) should |
| | | be answered by the issuing insurer(s). |
| | | As used here, the limit should be |
| | | listed as a whole dollar amount, as |
| | | governed by the policy. |
| COVERAGE | Products- | Enter limit: The general liability, |
| INFORMATION | Comp/Op Agg $ | products and completed operations |
| | | aggregate limit amount. Any questions |
| | | about appropriate limits or applicable |
| | | policy coverage(s) should be |
| | | answered by the issuing insurer(s). As |
| | | used here, the limit should be listed as |
| | | a whole dollar amount, as governed |
| | | by the policy. |
| COVERAGE | Other Limits | Enter text: The description of other |
| INFORMATION | | coverage (not the limit) on the general |
| | | liability policy. Any questions about |
| | | appropriate limits or applicable policy |
| | | coverage(s) should be answered by |
| | | the issuing insurer(s). |
| COVERAGE | Other | Enter limit: The general liability, other |
| INFORMATION | Occurrence $ | coverage limit amount. Any questions |
| | | about appropriate limits or applicable |
| | | policy coverage(s) should be |
| | | answered by the issuing insurer(s). |
| COVERAGE | Insr Ltr | Enter code: The Company Letter of the |
| INFORMATION | | insurer, as identified in the “Insurer(s) |
| | | Affording Coverage” form section, |
| | | associated with the policy. |
| COVERAGE | Automobile | Check the box (if applicable): Indicates |
| INFORMATION | Liability - Any | the commercial vehicle policy covers |
| | Auto | any auto. As used here, complete this |
| | | section only if you are certifying |
| | | automobile liability. Check all |
| | | appropriate boxes to correspond with |
| | | the covered auto symbols found on |
| | | the policy declarations page. If the |
| | | certificate is being issued to the owner |
| | | of a leased vehicle, DO NOT USE |
| | | THIS FORM. Use ACORD 23, Vehicle |
| | | or Equipment Certificate of Insurance. |
| COVERAGE | All Owned | Check the box (if applicable): Indicates |
| INFORMATION | Autos | the commercial vehicle policy covers |
| | | owned autos only. |
| COVERAGE | Hired Autos | Check the box (if applicable): Indicates |
| INFORMATION | | the vehicle policy covers hired autos |
| | | only. |
| COVERAGE | Other Covered | Check the box (if applicable): Indicates |
| INFORMATION | Auto | the vehicle policy covers autos other |
| | | than those listed. |
| COVERAGE | Other Covered | Enter text: The description of the other |
| INFORMATION | Auto Description | covered autos. |
| COVERAGE | Scheduled | Check the box (if applicable): Indicates |
| INFORMATION | Autos | the vehicle policy covers scheduled |
| | | autos. |
| COVERAGE | Non- Owned | Check the box (if applicable): Indicates |
| INFORMATION | Autos | the vehicle policy covers non-owned |
| | | autos only. |
| COVERAGE | Other Covered | Check the box (if applicable): Indicates |
| INFORMATION | Auto | the vehicle policy covers autos other |
| | | than those listed. |
| COVERAGE | Other Covered | Enter text: The description of the other |
| INFORMATION | Auto Description | covered autos. |
| COVERAGE | Addl Insd | Enter Y for a “Yes” response. Input N |
| INFORMATION | | for “No” response. Indicates if the |
| | | certificate holder has been named as |
| | | an additional insured on the |
| | | automobile liability policy. |
| COVERAGE | Subr Wvd | Enter Y for a “Yes” response. Input N |
| INFORMATION | | for “No” response. Indicates if |
| | | subrogation has been waived on the |
| | | automobile policy. |
| COVERAGE | Policy Number | Enter identifier: The identifier assigned |
| INFORMATION | | by the insurer to the automobile |
| | | liability policy, or submission, being |
| | | referenced exactly as it appears on |
| | | the policy, including prefix and suffix |
| | | symbols. If required for self-insurance, |
| | | the self-insured license or contract |
| | | number. |
| COVERAGE | Policy Eff | Enter date: The effective date of the |
| INFORMATION | (MM/DD/YYYY) | automobile liability policy. The date |
| | | that the terms and conditions of the |
| | | policy commence. |
| COVERAGE | Policy Exp | Enter date: The date on which the |
| INFORMATION | (MM/DD/YYYY) | terms and conditions of the |
| | | automobile liability policy will expire. |
| COVERAGE | Combined | Enter limit: The vehicle combined |
| INFORMATION | Single Limit $ | single limit liability each accident |
| | | amount. Any questions about |
| | | appropriate limits or applicable policy |
| | | coverage(s) should be answered by |
| | | the issuing insurer(s). As used here, |
| | | the limit should be listed as a whole |
| | | dollar amount, as governed by the |
| | | policy. |
| COVERAGE | Bodily Injury | Enter limit: The vehicle policy, bodily |
| INFORMATION | (Per Person) $ | injury per person limit amount. Any |
| | | questions about appropriate limits or |
| | | applicable policy coverage(s) should |
| | | be answered by the issuing insurer(s). |
| | | As used here, the limit should be |
| | | listed as a whole dollar amount, as |
| | | governed by the policy. |
| COVERAGE | Bodily Injury | Enter limit: The vehicle policy, bodily |
| INFORMATION | (Per Accident) $ | injury per accident limit amount. Any |
| | | questions about appropriate limits or |
| | | applicable policy coverage(s) should |
| | | be answered by the issuing insurer(s). |
| COVERAGE | Property | Enter limit: The vehicle policy, property |
| INFORMATION | Damage | damage per accident limit amount. |
| | | Any questions about appropriate limits |
| | | or applicable policy coverage(s) |
| | | should be answered by the issuing |
| | | insurer(s). As used here, the limit |
| | | should be listed as a whole dollar |
| | | amount, as governed by the policy. |
| COVERAGE | Other | Enter text: The description of the |
| INFORMATION | Description | coverage. |
| COVERAGE | Other Limit | Enter limit: The limit amount of the |
| INFORMATION | | other coverage. |
| COVERAGE | Insr Ltr | Enter code: The Company Letter of the |
| INFORMATION | | insurer, as identified in the “Insurer(s) |
| | | Affording Coverage” form section, |
| | | associated with the commercial |
| | | excess or umbrella liability policy. |
| COVERAGE | Umbrella Liab | Check the box (if applicable): Indicates |
| INFORMATION | | the type of policy is umbrella. As used |
| | | here, if evidencing an umbrella |
| | | coverage, underlying policy |
| | | number(s), term(s) and line(s) of |
| | | business may be listed on an ACORD |
| | | 101. |
| COVERAGE | Excess Liab | Check the box (if applicable): Indicates |
| INFORMATION | | the type of policy is excess. As used |
| | | here, if evidencing an excess |
| | | coverage, underlying policy |
| | | number(s), term(s) and line(s) of |
| | | business may be listed on an ACORD |
| | | 101. |
| COVERAGE | Type of | Check the box (if applicable): Indicates |
| INFORMATION | Insurance - | “coverage trigger” is on an occurrence |
| | Excess/Umbrella | basis on an excess or umbrella |
| | Liability - | liability policy. |
| | Occur | |
| COVERAGE | Claims-Made | Check the box (if applicable): Indicates |
| INFORMATION | | the “coverage trigger” is on a claims- |
| | | made basis on an excess or umbrella |
| | | liability policy. |
| COVERAGE | Deductible | Check the box (if applicable): Indicates |
| INFORMATION | | a deductible amount applies to the |
| | | excess or umbrella liability policy. |
| COVERAGE | Retention | Check the box (if applicable): Indicates |
| INFORMATION | | a retention amount applies to the |
| | | excess or umbrella liability policy. |
| COVERAGE | $ Field Box | Enter deductible: The excess or |
| INFORMATION | | umbrella liability deductible or |
| | | retention amount. |
| COVERAGE | Addl Insd | Enter Y for a “Yes” response. Input N |
| INFORMATION | | for “No” response. Indicates if the |
| | | certificate holder has been named as |
| | | an additional insured on the |
| | | umbrella/excess liability policy. Place |
| | | a “Y” next to each coverage where an |
| | | additional insured endorsement has |
| | | been issued or for umbrella/excess |
| | | where there is an additional insured |
| | | on the underlying primary policy and |
| | | this umbrella/excess is follow form. |
| COVERAGE | Subr Wvd | Enter Y for a “Yes” response. Input N |
| INFORMATION | | for “No” response. Indicates if |
| | | subrogation has been waived on the |
| | | excess policy. For umbrella/excess, |
| | | place a “Y” next to each coverage |
| | | where subrogation has been waived |
| | | on the underlying primary policy and |
| | | this umbrella/excess is follow form. |
| COVERAGE | Policy Number | Enter identifier: The identifier assigned |
| INFORMATION | | by the insurer to the excess liability |
| | | policy, or submission, being |
| | | referenced exactly as it appears on |
| | | the policy, including prefix and suffix |
| | | symbols. If required for self-insurance, |
| | | the self-insured license or contract |
| | | number. |
| COVERAGE | Policy Eff | Enter date: The effective date of the |
| INFORMATION | (MM/DD/YYYY) | excess liability policy. The date that |
| | | the terms and conditions of the policy |
| | | commence. |
| COVERAGE | Policy Exp | Enter date: The date on which the |
| INFORMATION | (MM/DD/YYYY) | terms and conditions of the excess |
| | | liability policy will expire. |
| COVERAGE | Limits - Each | Enter limit: The excess or umbrella |
| INFORMATION | Occurrence $ | liability each occurrence limit. As used |
| | | here, the limit should be listed as a |
| | | whole dollar amount, as governed by |
| | | the policy. Any questions about |
| | | appropriate limits or applicable policy |
| | | coverage(s) should be answered by |
| | | the issuing insurer(s). |
| COVERAGE | Aggregate $ | Enter limit: The excess or umbrella |
| INFORMATION | | liability aggregate limit should be |
| | | listed as whole dollar amount, as |
| | | governed by the policy. Any questions |
| | | about appropriate limits or applicable |
| | | policy coverage(s) should be |
| | | answered by the issuing insurer(s). |
| COVERAGE | Field Box | Enter text: The description of other |
| INFORMATION | | coverage (not the limit) on the excess |
| | | or umbrella liability policy. Any |
| | | questions about appropriate limits or |
| | | applicable policy coverage(s) should |
| | | be answered by the issuing insurer(s). |
| COVERAGE | $ Field Box | Enter limit: The excess or umbrella |
| INFORMATION | | liability and other coverage limit |
| | | should be listed as a whole dollar |
| | | amount, as governed by the policy. |
| | | Any questions about appropriate limits |
| | | or applicable policy coverage(s) |
| | | should be answered by the issuing |
| | | insurer(s). |
| COVERAGE | Insr Ltr | Enter code: The Company Letter of the |
| INFORMATION | | insurer, as identified in the “Insurer(s) |
| | | Affording Coverage” form section, |
| | | associated with the commercial |
| | | workers' compensation and |
| | | employers' liability policy. |
| COVERAGE | Type of | Enter Y for a “Yes” response. Input N |
| INFORMATION | Insurance - | for “No” response. Indicates whether |
| | Workers | the workers compensation and |
| | Compensation | employer's liability policy exclude any |
| | and Employers' | proprietor, partner, executive officer, |
| | Liability - Any | or member. As used here, this |
| | Proprietor/Partner/ | question is mandatory in New |
| | Executive/Excluded? | Hampshire. |
| COVERAGE | Subr Wvd | Enter Y for a “Yes” response. Input N |
| INFORMATION | | for “No” response. Indicates if |
| | | subrogation has been waived on the |
| | | workers' compensation policy. |
| COVERAGE | Policy Number | Enter identifier: The identifier assigned |
| INFORMATION | | by the insurer to the workers' |
| | | compensation and employers' liability |
| | | policy, or submission, being |
| | | referenced exactly as it appears on |
| | | the policy, including prefix and suffix |
| | | symbols. If required for self-insurance, |
| | | the self-insured license or contract |
| | | number. |
| COVERAGE | Policy Eff | Enter date: The effective date of the |
| INFORMATION | (MM/DD/YYYY) | workers' compensation and |
| | | employers' liability policy. The date |
| | | that the terms and conditions of the |
| | | policy commence . . . |
| COVERAGE | Policy Exp | Enter date: The date on which the |
| INFORMATION | (MM/DD/YYYY) | terms and conditions of the workers' |
| | | compensation and employers' liability |
| | | policy will expire. |
| COVERAGE | Limits - Per | Check the box (if applicable): Indicates |
| INFORMATION | Statute | that workers compensation coverage |
| | | is per statute. |
| COVERAGE | Limits - Other | Check the box (if applicable): Indicates |
| INFORMATION | | that additional coverage above the |
| | | workers' compensation statutory limits |
| | | apply (permitted in some states). |
| COVERAGE | Field Box | Enter text: The description of other |
| INFORMATION | | coverage (not the limit) on the |
| | | workers' compensation and |
| | | employers' liability policy. Any |
| | | questions about appropriate limits or |
| | | applicable policy coverage(s) should |
| | | be answered by the issuing insurer(s). |
| | | As used here, the DESCRIPTION OF |
| | | OPERATIONS section is available if |
| | | more space is required. |
| COVERAGE | E.L. Each | Enter limit: The workers' compensation |
| INFORMATION | Accident $ | and employers' liability policy, |
| | | employers' liability each accident limit |
| | | amount. Any questions about |
| | | appropriate limits or applicable policy |
| | | coverage(s) should be answered by |
| | | the issuing insurer(s). |
| COVERAGE | E.L. Disease- | Enter limit: The workers' compensation |
| INFORMATION | EA Employee $ | and employers' liability policy, |
| | | employers' liability disease each |
| | | employee limit amount. Any questions |
| | | about appropriate limits or applicable |
| | | policy coverage(s) should be |
| | | answered by the issuing insurer(s). As |
| | | used here, the limit should be listed as |
| | | a whole dollar amount, as governed |
| | | by the policy. |
| COVERAGE | E.L. Disease- | Enter limit: The workers' compensation |
| INFORMATION | Policy Limit $ | and employers' liability policy, |
| | | employers' liability disease policy limit |
| | | amount. Any questions about |
| | | appropriate limits or applicable policy |
| | | coverage(s) should be answered by |
| | | the issuing insurer(s). |
| COVERAGE | Insr Ltr | Enter code: The Company Letter of the |
| INFORMATION | | insurer, as identified in the “Insurer(s) |
| | | Affording Coverage” form section, |
| | | associated with the other policy. |
| COVERAGE | Type of | Enter text: The description of the other |
| INFORMATION | Insurance - Other | policy not listed on the form. |
| COVERAGE | Addl Insd | Enter Y for a “Yes” response. Input N |
| INFORMATION | | for “No” response. Indicates if the |
| | | certificate holder has been named as |
| | | an additional insured on the other |
| | | policy. |
| COVERAGE | Subr Wvd | Enter Y for a “Yes” response. Input N |
| INFORMATION | | for “No” response. Indicates |
| | | subrogation has been waived on the |
| | | other policy. |
| COVERAGE | Policy Number | Enter identifier: The other policy |
| INFORMATION | | number exactly as it appears on the |
| | | policy, including prefix and suffix |
| | | symbols. |
| COVERAGE | Policy Eff | Enter date: The date on which the |
| INFORMATION | (MM/DD/YYYY) | terms and conditions of the other |
| | | policy commence. |
| COVERAGE | Policy Exp | Enter date: The date on which the |
| INFORMATION | (MM/DD/YYYY) | terms and conditions of the other |
| | | policy expires. |
| COVERAGE | Coverage Code | Enter code: The coverage code for the |
| INFORMATION | | other policy. |
| COVERAGE | Limits | Enter limit: The other policy, coverage |
| INFORMATION | | limit amount. Any questions about |
| | | appropriate limits or applicable policy |
| | | coverage(s) should be answered by |
| | | the issuing insurer(s). As used here, |
| | | the limit should be listed as a whole |
| | | dollar amount, as governed by the |
| | | policy. |
| COVERAGE | Coverage Code | Enter code: The coverage code for the |
| INFORMATION | | other policy. |
| COVERAGE | Limits | Enter limit: The other policy, coverage |
| INFORMATION | | limit amount. Any questions about |
| | | appropriate limits or applicable policy |
| | | coverage(s) should be answered by |
| | | the issuing insurer(s). As used here, |
| | | the limit should be listed as a whole |
| | | dollar amount, as governed by the |
| | | policy. |
| COVERAGE | Coverage Code | Enter code: The coverage code for the |
| INFORMATION | | other policy. |
| COVERAGE | Limits | Enter limit: The other policy, coverage |
| INFORMATION | | limit amount. Any questions about |
| | | appropriate limits or applicable policy |
| | | coverage(s) should be answered by |
| | | the issuing insurer(s). As used here, |
| | | the limit should be listed as a whole |
| | | dollar amount, as governed by the |
| | | policy. |
| COVERAGE | Description of | Enter text: The Certificate of Liability |
| INFORMATION | Operations/ | Insurance general remarks. The |
| | Locations/Vehicles | additional comments or special |
| | | conditions that may exist upon the |
| | | policy. ACORD 101, Additional |
| | | Remarks Schedule, may be attached |
| | | if more space is required. As used |
| | | here, records information necessary |
| | | to identify the operations, locations, |
| | | and vehicles for which the certificate |
| | | was issued. |
| CERTIFICATE | Certificate | Enter text: The certificate holder's full |
| HOLDER | Holder Name & | name. |
| | Address | |
| CERTIFICATE | | Enter text: The certificate holder's |
| HOLDER | | mailing address line one. |
| CERTIFICATE | | Enter text: The certificate holder's |
| HOLDER | | mailing address line two. |
| CERTIFICATE | | Enter text: The certificate holder's |
| HOLDER | | mailing address city name. |
| CERTIFICATE | | Enter code: The certificate holder's |
| HOLDER | | mailing address state or province |
| | | code. |
| CERTIFICATE | | Enter code: The certificate holder's |
| HOLDER | | mailing address postal code. |
| SIGNATURE | Authorized | Sign here: Accommodates the |
| | Representative | signature of the authorized |
| | | representative (e.g., producer, agent, |
| | | broker, etc.) of the company(ies) listed |
| | | on the document. This is required in |
| | | most states. |

The instant invention provides for COI hashing and timestamping. Hashing or a hash function is any function that can be used to map data of arbitrary size to fixed-size values. The values returned by a hash function are called hash values, hash codes, digests, or simply hashes. The values are used to index a fixed-size table called a hash table.

A COI can be hashed to a distributed ledger technology and timestamped. At a later time, if some wants to verify the date/authenticity of this document it can be upload it to a website—or click a link/button in the document—to see history of this document.

The instant invention provides for Zero Knowledge Proof of Insurance Information.

Companies want to minimize the amount of information they share when proving they comply with their customer's insurance requirements. An embodiment of the instant invention uses Zero Knowledge proof (ZKP) to prove to the requestor (certificate holder) that an insured complies with their insurance requirements without having to disclose additional details about the insurance policy. For example, if an insured has $10 million in commercial general liability insurance, it does not need to disclose the entire amount to a counterparty (certificate holder) that only is requiring that the insured has at least $2 million of insurance coverage. Instead of disclosing the full $10 million limit, the zero-knowledge proof will return a “true” value. By returning a value of true it provides the information for the certificate holder that the insured has equal or greater insurance coverage.

Another example would be to determine if an insured has insurance that matches specific requirements which are in the system with regard to certificate holder. Alternatively, the instant invention could use ZKP to return a “true” value, based on data on the distributed ledger from the carrier and broker.

The instant invention uses a token to Prove Insurance. The system uses the ERC721 tokens which is a standard for non-fungible tokens and the instant invention associates the non-fungible token to each document that is tracked by the system. The token metadata contains all the attributes extracted from the document. Therefore, when a party shares evidence of a certification—or insurance—they effectively share the non-fungible token.

The instant invention is capable of extracting the Insurance Requirements from a Contract and Automatically Initiating a compliance workflow. This is accomplished by the user uploading a contract with a vendor to the system. The system extracts the insurance requirements and creates insurance compliance requirements and starts the insurance verification process to verify coverage. The following process can be used by the system of the instant invention:

1) A requester creates or edits insurance or compliance requirements in the instant invention application; or

2) A requester can upload a contract with a Vendor and the instant invention can extract the insurance requirements directly from the contract using Natural Language Processing (AI); or

3) The embodiment of the invention can also automatically scan a shared folder to look for new COIs if or when a new contract is added to a folder, the embodiment of the invention can automatically start the appropriate workflow such as the insurance verification process and verifies coverage.

The instant invention uses Natural Language Processing to interpret the data from an uploaded document. The instant invention can automatically identify “Declaration pages”, using Natural Language Processing and Machine Learning, so a user can save time by finding a particular page in a long-scanned document.

The embodiment of the invention can also review an insurance document such as a policy to identify the location where relevant information or material pertaining to an insurance requirement is located to reduce the time required by the user to find and identify the information. The instant invention also uses Natural Language Processing and Machine Learning to expedite a number of tasks related to finding and identifying information in a document. For example, if the user is reviewing a policy to identify potential exclusions, when clicking on an “exclusions” button, the Natural Language Processing of the instant invention will highlight areas in the document that it determines are relevant. The instant invention can also automatically extract structured data from a policy such as an expiration date, a policy number, or policy limit.

The instant invention Natural Language Processing can also identify inconsistencies between documents provided and the requirements. For example, the requestor identifies requirements for their vendors. These can be insurance related, professional licensing, drivers' licenses, educational, etc. When the information is uploaded to comply, the rules engine of the instant invention checks that the information provided matches or exceeds the requirements. For example, if a vendor uploads a driver's license, the system can extract the expiration date from the license and confirm that the license has not expired. If a user has uploaded a COI and an insurance policy, then the system can extract data from the insurance policy such as policy number and coverage limits. If there is an inconsistency with data on the COI or with another document, the instant invention will flag that inconsistency. The requestor can then approve, reject, or waive the compliance requirement.

Other documents that the Natural Language Processing module is capable of interpreting the data can include, but are not limited to, certificates of insurance, insurance policies, insurance endorsements, binders, memorandums, trade license documentation, government documents, COIs, agreements, and/or any document which pertains to the business, business operations, and/or insurance of any of the aforementioned user types and/or use cases listed here.

The instant invention using the Natural Language Processing module and operating in the real-time monitoring mode can monitor a shared folder and extract structured data from insurance documents placed in the folder and identify conflicts in the documents. For example, if two documents both have the same policy number but have differing expiration dates, this information would be flagged to the user. By identifying conflicts, the instant invention provides an automated process to identify risk.

The instant invention has a log-in tool which allows users to log into their carrier/broker via Third Party sites and share insurance details. This is similar to how the fintech Plaid platform allows users to log into their bank accounts via third party websites.

This functionality allows the users to share insurance details instead of requiring customers to contact their broker and have their broker lookup data and create certificates of insurance, they can simply select their preferred bank/credit union and enter their credentials. Once the link has been established, the instant invention can pull data about the user's insurance. The system also allows the user to choose what information—if any—they want to share.

The instant invention provides benefits to mortgage, automotive purchasing and equipment leasing processes. For example, as a homebuyer, it is desirable to have a more efficient way to share insurance information with parties involved in the home closing.

During the purchasing process, proof of insurance is required to get a mortgage or car loan approval. The instant invention reduces the process to a series of simple steps which are handled by the system and the data needed by all parties is provided in a timely manner.

The instant invention also has a Certificate of Insurance (COI) Structured Data Extraction Tool. Upload COI, and structured data is extracted, such as policy limits, name of insured, expiration dates, or carrier information. The system of the invention for COIs utilizes Optical Character Recognition (OCR) and machine learning to improve the quality of the OCR to extract data from the COI. The user can review structured data to verify it is accurate and if the data cannot be automatically extracted, then the system automatically routes to the proper party for review.

The instant invention provides enhancements for the Insurance Marketplace. The instant invention provides the following features:
a. A requestor can easily offer/require that their vendor/supplier signup can add widget onto their website to allow user to easily signup to a captive insurance group. A widget is an application, or a component of an interface, that enables a user to perform a function or access a service.
b. For those users who have brokers/carriers that do not offer a Live Certification, the instant invention can introduce them to a broker/carrier who uses the instant invention system.
c. The instant invention offers a marketplace for Brokers/Carriers to provide introductions to potential customers for a fee.
d. Brokers/carriers using the instant invention will have the opportunity to offer prospective customers insurance policy quotes. Advertising brokers/carriers do not receive customer details until the customer ops in, however the advertising brokers/carriers are able to offer leads quotes based on an Insured's existing policy numbers.

The instant invention provides risk managers a marketplace which is capable of introducing customers to bookkeepers. Insurance brokers can also use this service for their existing customers. The instant invention offers users a charge to find/select part-time Risk Managers whom they can work with. Additionally, risk managers can set their own prices and get paid via the system of the instant invention. The instant invention is paid a commission for the introduction.

A small-to-medium enterprise (SME) is defined as an organization that is somewhere between the “small office-home office” (SOHO) size and the larger enterprise. Additionally, many SMEs cannot afford a dedicated risk manager and other insurance/risk consultants. On the system platform, SME can get connected to a risk manager who can work with them on a part-time basis. This is similar to what Quicken does for accountants. The system can provide links that when executed will provide a list of prequalified risk managers to choose from. This functionality is similar to how QuickBooks offers to introduce customers to bookkeepers. The system offers the client a list of prequalified risk managers to choose from so they can find/select part-time Risk Managers whom they can work with. This creates a marketplace where the user can search/review profiles of Risk Managers.

The risk managers can set their own prices and get paid via a system of the invention. The system makes the connection between the selected risk manager and the client and the system charges the client the fee for the risk manager plus a transaction fee which is collected by the system. The transaction fee is a commission. This is similar to the commission collected by a ride sharing service. In addition, the present invention can be used to sell services to the brokers so they can resell them. The brokers would buy the services at a wholesale price and resell them at a retail price.

The instant invention provides additional features for Insurance (Brokers/Carriers/Digital MGAs/Captives/Reinsurance). For those users who have brokers/carriers that do not offer a Live Certification, the instant invention can provide introductions to a broker/carrier who uses the system.

The system of the invention provides a marketplace for Brokers/Carriers to pay to be introduced to potential customers. For example, if the Insured does not have the necessary coverage, they will automatically receive quotes for the additional insurance. Additionally, if an insured is working with a Broker/Carrier that does not automatically provide evidence of coverage, then the system of the invention will notify the user that their Broker/Carrier is using legacy technology and will offer to introduce them to a Broker who can provide Live Evidence of Coverage.

The system of the invention provides underwriting improvements with regards to:
a. Policy renewal where the underwriters can automatically send forms to Insureds at renewal time to ask them for additional information prior to renewal.
b. Real-time auditing where the carriers/brokers have real-time metrics for the number of COIs issued and details of certificate holders to identify new risks for an insured. A typical example would be if a painting company said he has only 3 painters on their staff, but issues 100 COIs, this might suggest the painting company is larger than estimated and his policy should be modified. Another example would be if a residential painting company said he does not work on bridges, if a COI certificate holder name has the word “bridge” in it, then the Carrier/Broker is automatically notified so that he can offer the insured the correct insurance coverage.

The instant invention is also capable of providing COI Website tools for brokers.

When the instant invention is capable of providing a COI Request JavaScript Widget for a broker website, the broker can download the widget and add the widget onto the broker website to allow a user to easily initiate COI request.

The instant invention is also capable of offering brokers a white-labeled site that helps their clients track insurance and documents.

The system of the invention provides service providers (Insureds/Vendors/Subcontractors, etc.) enhanced capabilities.

Service providers using the instant invention are included in a marketplace categorized by trade and/or service area as well as location and any other data segmentation detail possible to provide service procurers a trusted place to find vendors the process for being included in the marketplace is based on:
a. ability to provide live evidence of coverage.
b. licensed professional in that industry.
c. they have insurance.
d. service procurers (requesters).

Service procurers can advertise themselves on the system to investment and lending partners as well as provide ways for service providers to connect with local procurers. The process for a service provider to advertise requires them to sign up to be represented by the instant invention marketplace. As part of that onboarding process, they are required to provide information which validates their identity. Once the service provider is validated then the system initiates both supplier information dialog information and payment mechanism so that the service provider can receive payment from the system.

The instant invention provides integration of data products and solutions.

An embodiment of a system of the invention is capable of interfacing with critical business management applications such as Integration/Application for AMSs (agency management systems' such as, but not limited to Applied Epic), Customer Relation Managers (CRMs) such as, but not limited to SalesForce, accounting and financial software such as, but not limited to QuickBooks, Enterprise Resource Planning (ERP) systems, such as, but not limited to SAP, Vendor Management system, and additional 3rd party systems. For example, for users who use one of these third-party tools, can integrate with the embodiment of the invention, synchronize their contacts/vendors, and create compliance/insurance requirements. The embodiment of the invention will then commence its business processes to verify coverage and compliance. Data will then be returned to the third-party application and the third-party application user will see vendor/contact compliance information directly inside that third-party application. Put another way, the user will be able to use the embodiment of the invention without needing to leave SalesForce. The integration with the third-party application can connect to the invention via API, an app on the third party's marketplace, or via the invention's Corda application.

An embodiment of the instant invention may be capable of data sharing and/or data verification products and/or solutions for project management software such as, but not limited to ProCore, AutoDesk, BIM, property management software such as, but not limited to AppFolio, and/or online vendor directories in all product/service related verticals and industries such as, but not limited to: Buildzoom, Building Connected, Snapdocs, Angie's List, Thumbtack, Venassure, Home Advisor, BBB, eLocal, Yelp, Porch, Home flock and Networx.

Integrations to be done via on-premise hardware or software technology, the system of the invention API, distributed ledger technology, and/or proprietary, open-source, or other 3rd party technology. The API is just one of the multiple ways that data can get imported into the system of the invention ecosystem.

If a party does not run a Corda DLT Node with the instant invention application, then the system can communicate with that party using API.

Similar to the Plaid software system, the instant invention allows the users who are logged into their carrier/broker accounts via Third Party site and share insurance details. This is similar to how Plaid allows users to log into their bank accounts via third-party websites. Instead of requiring customers to contact their broker and have their broker lookup data and create PDF certificates of insurance, they can simply select their preferred bank/credit union and enter their credentials. Once the link has been established, the instant invention can pull data about the user's insurance. They can then choose what information they want to share.

Upon receiving a paper-based COI or credential, the instant invention will extract information from the paper based document, classify the possible authorities for the information provided, such as the carrier or the broker identified in the document, and then perform a lookup to verify if the insured has the insurance coverage included in the document.

If a COI issuer or some other licensor provides a paper-based or electronic based credential or COI, the instant invention will include a QR code that allows any individual in receipt of that document to verify the accuracy of the information in the paper document.

If a certificate holder works with the same third party on multiple projects, the certificate holder can use the instant invention to identify compliance requirements on a project by project basis. For example, a general contractor who works with a plumber on two projects, can have different insurance requirements for the same plumber based on the location of the job site. A project can be any type of relationship that a requestor of information has with a third party. For example, this could include different loans, different apartment buildings, different portfolio companies, etc.

If an issuer of a COI or some other license does not use the instant invention, then the system can auto generate emails to determine that the paper-based document is still accurate.

Upon uploading a paper-based or electronic document, the system will extract information from the document and assess if the document meets the compliance requirements. If the information meets the compliance requirements, the system will start subsequent workflows.

The instant invention provides a Digital Managing Agent (MGA). An embodiment of the invention utilizes artificial intelligence and as it acquires more data, it leverages the data to provide simple and comprehensive insurance products to entities on the platform that are seeking insurance. The embodiment is capable of offering the Broker Marketplace, where it assesses a fee for introducing customers to brokers. However, the embodiment is also a broker portal for companys and part of the offerings are insurance products provided by the company directly to the system's clients.

Looking at the instant invention the instant invention platform can be summarized as a system that is designed to help organizations in collecting and tracking documents and certificates.

The document request is the primary vehicle that is sent to one or more contacts. Each contact creates a document which is uploaded in response to the request. Important events are logged, and time-stamped on the public distributed ledger technology.

Document attributes are defined in the document template, that is associated with the document request. The attributes needed for these are subsequently extracted from the uploaded document(s) and are verified by the requester upon reception of the document.

Each user can act as a requester (e.g. General Contractor), requestee (e.g. subcontractor), issuer (e.g. broker—can also upload the document in lieu of the requestee).

A document request can be sent to multiple contacts. The document request can have an associated workspace, which is the context where the document request happens.

The instant invention tracks the Certificate of Liability Insurance, also known as the ACORD 25 form (Table 1) which is an industry standard. The data need to complete an ACORD 25 COI includes:
a. Key entities
b. First name, Last name
c. Email
d. Role
e. Department
f. Organization
g. Address
h. Country
i. Region
j. City
k. Zip code

A user receives a document request via email with respect to a specific contact. The email recipient clicks on the link and gets redirected to the system, where they either enroll or log in if they already have an account. The user creates the workflow associated with the aforementioned contact, the contact becomes “bound” to a user. When a contact signs up they also provide information about their document issuers and provider. They will be able to forward current and future document requests to the specified issuer creating a collaboration data object. A collaboration data object is an OLE Messaging or Active Messaging, and it is an application programming interface used for building messaging or collaboration applications.

Attributes of the Contact model are:
a. First name, Last name
b. Organization Name
c. Email
d. Address
e. Country
f. Region
g. City
h. Zip code
i. Phone Number
j. User ID (when the contact is bound to a user)

A contact with the same email can be already present in the system under other organizations. When this occurs, a user sends a document request to that contact, they will be able to login with their existing User ID, and their User ID will be saved on that contact.

Contacts can be conceptually associated with vCards (vCard, also known as VCF, is a file format standard for electronic business cards) owned by organizations. The contacts list is the “Address Book” of the organization. A contact can reference a user, and a user can be referenced by many contacts in the system (across various organizations).

A collaboration is created when the recipient of a document request wants to delegate the document upload to a designated user. Attributes are:
a. collaborator ID (user).
b. contact Document Request ID.
c. token (used to associate newly created users to the collaboration).
d. role (e.g. uploader, reviewer).
e. message.
f. managed attributes which are definable by the user or system.
g. document request.

A document request is sent by a requester (User) to one or many requestee (Contact) and has an associated document template that specifies certain attributes, as described below. A requester can delegate the document upload to another user (e.g. to a broker) by inviting them to collaborate with the document request. One request can result in multiple documents being uploaded: each document provided by the contact can totally or partially satisfy the document request. As a matter of example, a request for a certificate of insurance can result in multiple certificates being uploaded, since such certificate references policies that can be issued by multiple insurers.

Attributes on the document request are:
a. name
b. description
c. document Template ID
d. workspace ID
e. author (the user who created the document request)
f. contact document Request

A document request is sent to many contacts, and contacts can receive many document requests. Therefore, a relationship table is used to associate these two entities. In this relationship table (representing the document request being sent to the specified contact) we save specialized attributes, such as:
a. due date
b. status (accepted, not accepted, in progress, expiring)
c. notes (this could be extracted to a separate model and used for other entities as well)
d. attributes (from the document template)
e. valid From
f. valid Until

When the contact receives the contact document request, they can invite other users (existing or new) to collaborate on that document request. This is done by creating a collaboration. A collaboration references a collaborator (a user that can be invited by the document request recipient) with a specified role (e.g. uploader, reviewer).

The instant invention document template is a sample document that describes the document that should be provided by the requestee (contacts), and the attributes that are expected to be found on it. Attributes can have different types (date, numeric, string, Boolean). A document template has a sample document attached (PDF), that can be used by the contact as a reference (example here). It also defines a set of attributes that will be extracted from the document uploaded by the contact, using a service such as DocParser. Docparser is an intuitive and scalable solution for automating your PDF data entry.

Attributes for the document template are:
a. name
b. description
c. sample document
d. attributes

Since the first and most important use case are built around the ACORD 25 form, the instant invention has a default document template that all organizations are able to access and use.

Document upload is a feature of the contact document request. Created by the requestee (or by the collaborator, in case the requestee decided to delegate the upload) in response to a contact document request. It can have many versions, e.g. the first uploaded document contains an error, the requester follows up, and the requestee uploads a new version. The uploaded document gets parsed and the extracted attributes are presented to the requested: based on what is found, the requester can decide whether the contact document requested should be considered accepted, declined, or pending.

Workspace is the context in which document requests occur. A workspace has many document requests. A workspace can represent a project, a recurring activity, a vehicle, etc. Several documents can be requested to contacts. A contact can receive more than one document request in the same workspace. To be evaluated, the concept of “workspace asset”, which can represent a more specific association to a document request within the context of the workspace (e.g. a piece of equipment within a construction project).

The thread and message are related to a document request, or to a contact. It is used to follow up with contacts on outstanding document requests.
a. Tag and Bucket. (A system can associate multiple key-value pairs (tags) with each Amazon Simple Storage Structures (S3) object, with ability to change them at any time. The tags can be used to manage and control access, set up S3 Lifecycle policies, customize the S3 Analytics, and filter the CloudWatch metrics. You can think of the bucket as a data lake, and use tags to create a taxonomy of the objects within the lake. This is more flexible than using the bucket and a prefix and allows you to make semantic-style changes without renaming, moving, or copying objects.)
b. Used to group entities
c. Audit Event

Events that are considered worth tracking are logged in the audit events table. These events are logged, and time-stamped on the distributed ledger technology. Examples of audit events are document requests being sent to contacts, document being uploaded, messages being sent to contacts, document being approved or rejected, etc.

A typical scenario is a request to override where a certain requested document attributes (e.g. accepting coverage for a lower amount under specific circumstances). This will be handled with a request override model that references the contact document request, and will specify which attributes should be overridden, the reason and the approval/denial of the request.

The instant invention has several main sections which are part of the platform sitemap.
a. “documents and contacts” section where the user can access all the document requests and the contacts that belong to the organization.
b. main page documents and contacts.
c. displayed Information, shows all document requests and contacts across the whole organization.
d. a workspaces section that acts as a filter for the currently displayed document requests and contacts.
e. a selected workspace section in the main area that shows only document requests and contacts that pertain to the current workspace.

The user has the following user actions available to them.
a. view workspaces list page.
b. view document Request detail page.
c. view contact detail page.
d. expand contact from the list (shows additional details for quick access).
e. create new workspace.
f. create a new document request.
g. create new contact.
h. view uploaded document detail page (accessible from expanded contact in the list).
i. subpage: workspaces list page.
j. displayed information.
k. displays a list of workspaces, with associated users and permissions.
l. user actions.
m. add a workspace.
n. view workspace.
o. subpage: view workspace page.
p. displayed information.
q. workspace name, workspace description, users associated with the workspace and relative permissions.
r. timeline of activities on the workspace (document requests, document uploads).
s. user actions.
t. go to edit workspace details.
u. add user to the workspace.
v. manage users' permissions.
w. subpage: view document request page.
x. displayed information.
y. document request details (name, description).
z. associated template.
aa. contacts (requestees) associated with the document request.
bb. documents uploaded by contacts.
cc. Status of the request by each contact (pending, uploaded, expiring, expired/not compliant).
dd. Timeline of activities on the document request.
ee. user actions.
ff. go to edit document request details.
gg. add a contact to the request.
hh. remove a contact from the request recipients list (cancels the document request for that contact).
ii. view uploaded document.
jj. subpage: view uploaded document page.
kk. displayed information.
ll. uploaded document displayed in PDF viewer.
mm. extracted attributes from uploaded PDF.
nn. document timeline, with all relevant events.
oo. message thread with contact.
pp. user actions.
qq. approve the document.
rr. follow-up to request additional information.
ss. set a grace period after which the document will be declared non-compliant if no actions.
tt. subpage: view contact page.
uu. displayed information.
vv. contact information, such as name, address, email, phone number.
ww. associated workspaces.
xx. requested and uploaded documents grouped by workspace.
yy. user actions.
zz. go to edit contact information.
aaa. delete contact.
bbb. subpage: new/edit workspace page.
ccc. displayed Information.
ddd. fields for creating the new workspace: name, description.
eee. area for adding members (users of the platform) and specify roles for each member.
fff. user actions.
ggg. create/edit the workspace.
hhh. add user to the workspace with the specified permission.
iii. subpage: new/edit document request page.
jjj. Displayed Information.
kkk. fields for creating the new document request: name, associated template.
lll. area for adding contacts to the document request.
mmm. user actions.
nnn. create/edit the document request.
ooo. add contacts to the document request.
ppp. subpage: new/edit contact page.
qqq. displayed information.
rrr. fields for creating the new contact: name, address, email, phone number.
sss. control for associating the contact to a workspace.
ttt. user Actions.
uuu. create/edit the contact.
vvv. add contact to a workspace.
www. “templates” section.
xxx. main page: templates.
yyy. displayed information

The main area shows a list of document templates, available across the whole organization.

On the left-hand side, there is a workspace section that acts as a filter for the currently displayed templates.

When the user selects a workspace, the main area shows the workspace specific templates and the global templates (all the template that can be used to request documents on that workspace). The following user actions are:
a. view document template.
b. create a new document template.
c. subpage: view document template page.
d. displayed information.
e. attributes associated with the document template.
f. control for marking the document template as globally accessible or for associating it to specific workspaces.
g. sample PDF.
h. user actions.
i. create the document template.
j. associate the document template to one or more workspaces or mark it as globally accessible.
k. subpage: new document template page.
l. displayed information.
m. user actions.
n. “reports” section.
o. main page: reports.
p. displayed information.

The main area shows a list of reports available across the whole organization (e.g. all outstanding requests, all non-compliant requests). The user can apply constraints such as time frames etc.

On the left-hand side, there is a Workspace section that will act as a filter for the currently displayed reports.

When the user selects a workspace, the main area will apply a scope to the currently displayed reports. The user actions are:
a. view report detail.
b. export report (CSV, Excel).
c. subpage: view report.
d. displayed information.
e. user actions.
f. subpage: new/edit report page.
g. displayed information.
h. user actions.
i. login sign up pages.

Service page where new users sign up. Standard information requested, such as first/last name, email address, basic organization information (that will be editable after sign up).
a. user profile page.
b. service page with user profile information.
c. organization page.
d. displayed information.
e. organization name and address.
f. list of users belonging to the organization.
g. user actions.
h. edit organization information.
i. manage existing users (add them to workspaces, edit permissions...)
j. invite new users.

The system of the invention utilizes a dashboard that allows the active parties to view compliance status FIG. 3.

Referring to FIG. 3 Dashboard 3000 has request initiation 3010, Active parties compliance status indicator 3020, the request tracking dashboard indicator 3030, The number of documents to review status indicator 3040, action items indicator 3050, request by status indicator 3060, Review documents uploaded to request indicator 3070, Subcontractor status indicator 3080, Requirement set indicator 3090, date search field 3100, updated certificate indicator 3110, New message indicator 3120.

Another feature of an embodiment of the invention includes the storage of the COI such that the user entities may perform transactions. The data is stored in distributed ledger technology/distributed ledger systems (BDLs) in different ways. For example, the user entities may interact with BDLs in various ways including (but not limited to): embedding, triggering, deploying, initializing, or otherwise integrating the COI code into a data-driven contract or clause, by calling ‘smart COI code that exists on BDLs, by compiling logic to the virtual machine bytecode of one or more BDL(s), interacting with the ABI (Application Binary Interface) of BDLs, by passing data/objects/arguments/functions/messages (or another entity) to existing on-chain smart COI code, through the use of a BDL API, and/or performing other suitable interactions. Herein, BDL is used herein to refer to distributed ledger systems and/or more specific consensus-based distributed ledger technology solutions, wherein any suitable variation of such systems may be used. Reference in this specification to BDL systems, platforms, integrations, transactions, and the like could be various distributed ledger variations or distributed ledger technology variations. Centralized BDL implementations, cryptographic databases, and/or other suitable systems with BDL-like features may be additionally or alternatively be used in a similar manner as the BDL components.

In order to perform these functionalities, computable COI, and ‘data-driven’ COI in particular, require a system and method through which COIs may be stored, displayed, and managed in a ‘dynamic’, ‘real-time’ or near ‘real-time’ manner. To facilitate such functionality, the instant invention preferably provides mechanisms to host COIs using a computer-based network such as a peer-to-peer (P2P) network so that a COI may interact with external data sources, may update and drive external operations and actions, and the contract may be viewed by the system of the invention by the parties and any other party that is given, or requires, access to the COI. Where COIs are dynamic, dependent upon, or linked to external data, and exclusively hosted in a computer-based format, there is an increased requirement for, and emphasis upon, security, authentication, and validation of both the formation and post-execution state of these COIs. A system of the embodiment of the invention is capable of monitoring any changes, modifications or updates made to their terms and conditions, as compared to PDF or paper-based COI documents. As such, the system and method can preferably provide approaches for secure version control of COIs so that:
a. changes made to their state--both before and after execution may be tracked, verified, and immutably recorded; and
b. operations with integration with any external or third-party system, application, or platform, may be tracked and verified (e.g. transactions on distributed ledgers, operations performed on external systems via. APIs, on network-connected devices, etc.).

FIG. 1 provides a high-level conceptual framework of a COI within the system showing interactions between the instant invention data layer (e.g., data from external sources such as APIs, IoT/edge computing devices, BDLs, ERP/IMS/CRM and other systems as mentioned herein), a layer (e.g., involved in forming and execution of data-driven/computable COIs), and a transaction layer upon which transactions and/or operations may be performed (e.g., BDL systems, ‘on-chain’/‘on-ledger’ code; APIs etc.).

The instant invention provides the method for the formation and post-formation versioning and management of computable COIs, including data-driven COIs. The instant invention provides stateful management, versioning, and storage of computable COIs and recording of input/output events from data-driven COIs and state changes, performance of transactions, and any other operations and events (e.g. recording of notice, termination, etc.).

The system and method may be used independently of other components and it can be a component part of a wider system or application.

The instant invention in one embodiment uses a cryptographic graph data structure that represents and may store the state of a contract. Objects may be immutably added to the graph in an append-only fashion when events, transactions, updates. The data structure provides a versioned history of the COI state that can be used, amongst other applications:
a. to query the data structure to display events such as audit trails and notifications; to provide analytics of the state of one or more COIs (e.g. metrics, graphs, dashboards);
b. by contract logic and/or ‘on-chain’/‘ion-ledger’ scripts (e.g. by using graph object states in execution of logic);
c. to audit or replay the state of the COI; and
d. to push or otherwise store the state of the COI, or part thereof, to BDLs. Other applications may be used.

The instant invention may be used with any suitable system for computable COIs. The system and method, in part or whole, may also be applicable to other documentation more broadly such as non-computable COIs. Herein, the system and method are described as being used with computable COIs, but one skilled in the art would appreciate applications to non-computable COIs. In one embodiment it uses the system and method in combination with a system and method for ‘data-driven’ COIs. Any form of data-driven COI may be used. Data-driven COIs are preferably composed in whole or in part in accordance with ACORD 25, in machine-readable code. However, they do not have to be, through ‘programmable clauses’ and do not have a number of attributes:
a. with clauses, terms and conditions that update or change in response to external data (notably from edge computing devices, ‘Internet of Things’ (IoT) devices, IoT platforms, ‘oracles’ for BDLs, adapters, Application Programming Interfaces (APIs), Customer Relationship Management (CRM) systems, Enterprise Resource Planning (ERP) systems, Inventory Management Software (IMS) systems, analytics systems, databases, BDLs etc.), rules, algorithms and legal logic/rules—COIs that are ‘dynamic’ or ‘real-time’ as opposed to static;
b. that output data processed through COIs to external systems, applications, platforms, databases and similar; and/or
c. combine “smart COI” execution functionality within the logic of data-driven COIs either through embedding, compilation to the bytecode of a BDL with a virtual machine or similar, passing data/objects/functions/arguments to existing ‘on-chain’/‘on-ledger’ code, deploying or initializing scripts ‘on-chain’/‘on-ledger’, via an RPC channel, API, or any other appropriate method. Herein, “smart COI” refers to “smart COI” code that is generally considered code executed by a system of an embodiment of the invention between two or more nodes that transactions or other data on a ledger or distributed ledger technology using a distributed ledger technology or distributed ledger system, or another similar system (e.g. a ‘distributed ledger technology’ database or other databases with distributed ledger technology or distributed ledger features).

The instant invention may be used with all computable COIs that are capable of accepting state updates or similar interaction, hybrid (part natural language, part-machine readable code) COIs. By being capable of extracting information from scanned input the problem associated with risk management.

The instant invention may be composed of a set of base components including (but not limited to): a COI data structure, update mechanism, an execution environment, an object ledger structure (e.g., for sharing state) and/or a BDL system (e.g., outside BDL on which transactions are executed), which are each described in detail in the sections below. The contract data structure may be a universal content-addressed and immutable data layer for computable COIs. The state update mechanism may be a mechanism for administering, managing, and recording the version and state of COIs. The execution environment may be an architecture for the formation, execution, and updating of computable COIs. The object ledger structures are ledger structures that may be distributed (e.g. a distributed ledger technology or other distributed ledger protocol) that may be used to, but is not limited to:
a. store and share objects/data from the contract and/or graph (e.g. for other parties, as a record, etc.) in whole or in part;
b. perform transactions using contract logic and graph data using ‘on-chain’/‘on-ledger’ code;
c. interact with objects, arguments, and data from the contract logic and/or the graph data structure through ‘on-chain’/‘on-ledger’ code); and
d. store data and perform transactions that do not emanate from, but may be related to, the contract such as IoT data, transactions on BDLs (e.g. trade finance transactions, asset transfers, tracking of goods, etc.).

Any appropriate combination of these components may be used in a given implementation. Not all components may be used, and additional and/or alternative components may be used. For example, some implementations may not make use of object ledger structures.

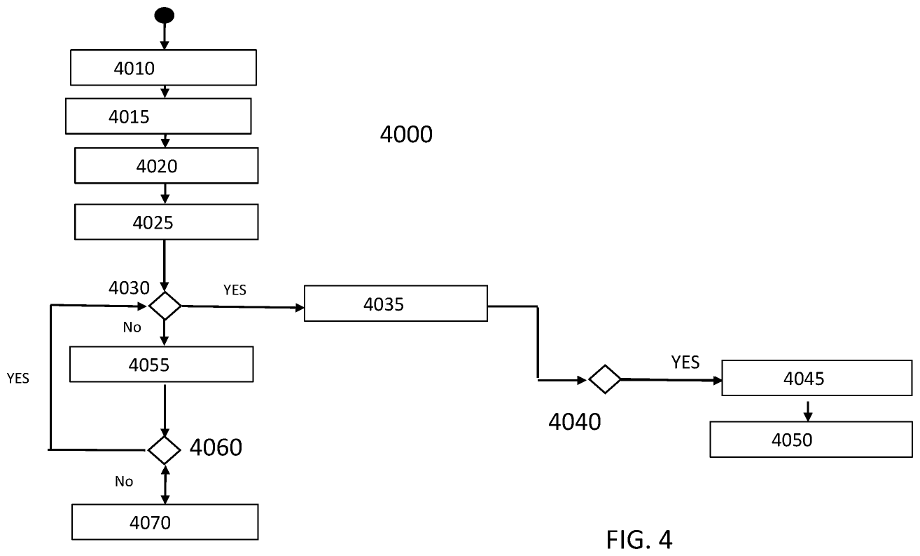

Turning attention to FIG. 4 which describes the distributed ledger technology workflow 4000.

The certificate holder sets the compliance requirements in step 4010.

Then the certificate holder sends proof of insurance request to the policyholder in step 4015.

Then the policyholder forwards proof of insurance request to broker/agent in step 4020.

The next step is the broker/agent receives request in step 4025.

The next step is a decision step where the question—Does policyholder have matching insurance coverage?—Step 4030.

If the answer to step 4030 is yes, then requirements are compared with policy attributes on the distributed ledger technology in step 4035.

The next step is a decision step where the question—can all requirements be automatically matched?—Step 4040.

If the answer is Yes to step 4040 then digital proof of insurance is created by the broker/agent step 4045 and then the digital proof of insurance is shared with the certificate holder and the carrier in step 4050.

If the answer to step 4030 is No, then broker request policyholder to purchase new insurance in step 4055. Then the system tests if the policyholder has purchased the new insurance in step 4060. If the insurance is purchased, then the transaction is transferred to step 4030, if the policyholder does not purchase new insurance the policyholder is notified that they do not meet the requirements in step 4070.

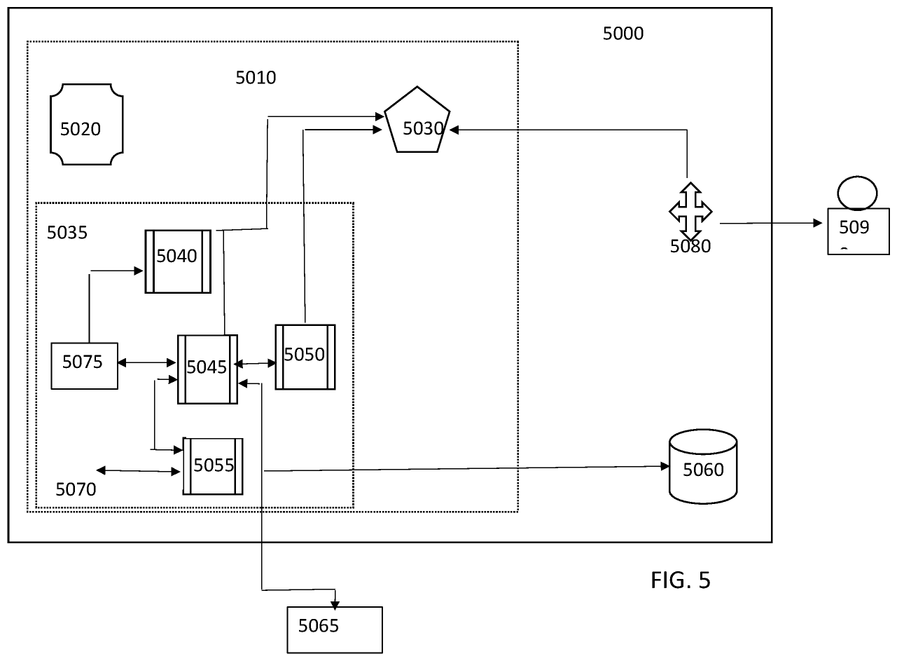

Turning attention to FIG. 5 which describes the network architecture 5000. The Kubernetes cluster 5010 consists of the master Kubernetes 5020 which is an open-source system for automating computer application deployment, scaling, and management. The Ingress controller Nginx Ingress 5030 which provides load balancing and a production containers Extractlayer 5040, API container 5045, Web application container 5050, Prisma container 5055. The NATS messaging system 5075 interfaces with the Extractlayer container 5040 and API container 5045. An embodiment of the invention can send relevant emails 5065 to the parties involved in the transaction and the parties can also upload files to the S3 bucket 5060. The Prisma container 5055 can store documents on the Mongo database 5070. The API container 5045 and web application container 5050 communicate with the NGINX Ingress controller which communicates with the end user 5090 using the Amazon route 53 DNS service 5080.

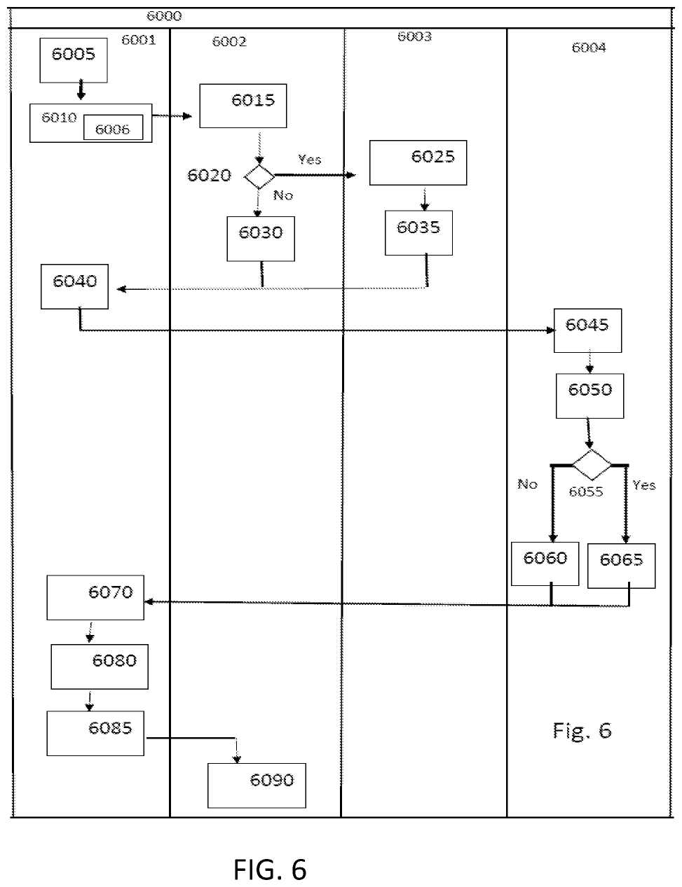

Turning attention to FIG. 6 which describes the proof of compliance workflow 6000. The following users are part of the process. Requesters 6001, the insured party 6002, the insurance producer 6003 and the document processing service 6004.

The Requester 6001 indicates compliance requirements in step 6005. The Requester sends the compliance request 6006 to the insured party 6002 in step 6010. The insured party 6002 receives the compliance request 6006 in step 6015 and the following occurs either the insured party 6002 forwards the request to the insurance producer 6003 or not in step 6020. If the insured party 6002 sends the request to the insurance producer 6003 in step 6025 the insurance producer 6003 provides documents to satisfy the request in step 6035. If the insured party 6002 does not send the request to the insurance producer 6003 in step 6020 and provides the documents to satisfy the request in step 6030. After steps 6035 and 6030 are complete then the requester 6001 receives documents as proof of compliance in step 6040.

The document processing service 6004 of an embodiment of the invention then uses the Extractlayer container and parses uploaded files and extracts document attributes in step 6045. The embodiment of the invention the runs extracted attributes from documents through a set of compliance requirements the requester 6001 has indicated in their request 6006 in step 6050. The system of an embodiment of the invention determines if the extracted data provides all compliance requirements in step 6055. If it does, it marks request 6006 as compliant in step 6065 or if it is not it marks request 6006 as non-compliant in step 6060.

The requester 6001 is then notified by the embodiment of the invention if the request 6006 is compliant or not in step 6070. The requester 6001 then decides if the request 6006 is ready to be finalized or manually changes the compliance status on the embodiment of the invention in step 6080.

Next, the requester 6001 finalizes the request 6006 with final request 6006 and insured party 6002 compliance status which is either compliant or non-compliant or the request 6006 is canceled. After step 6085, in the last step 6090 the embodiment of the invention notifies the insured party 6002.

The instant invention IVN—Insurance Verification Network

The Insurance Verification Network (IVN) describes how the instant invention enables parties so that they can request and share a digital proof of insurance through a dedicated DLT based network IVN.

A proof of insurance is a document that provides evidence of a specific insurance coverage, listing details such as coverage limits and the relevant endorsements. A traditional proof of insurance is typically provided on a PDF document or printed paper, and does not let the owner of such document receive updates on the policies listed in such document, nor gives the owner the ability to verify its authenticity. The distributed proof of insurance (DPOI) overcomes these limitations.

The following parties are involved in the process of requesting and obtaining a digital proof of insurance:
1. Party requesting a proof of insurance (the Requester, also Certificate Holder)
2. Party that is requested to prove insurance (the Insured, also Policyholder)
3. Party that provides the digital proof of insurance on behalf of the Insured (the Producer, also Broker/Agent)
4. Party that underwrites the insurance policy (the Carrier, also Insurer)

To implement this workflow using distributed ledger technologies, there are other logical entities that take part in the system:
1. Business Network Operator
2. Distributed Proof of Insurance Service (DPOIS)
3. Notary

The instant invention may be composed of multiple nodes—each one has a specific role and maps to an organization. An organization can also run multiple nodes, for example as requester and as policyholder.

The Business Network Operator issues identities to each participant and maintains a map of such identities to their respective nodes.

Multiple organizations to share a node (a Proxy Node), provided by the Distributed Proof of Insurance Service.

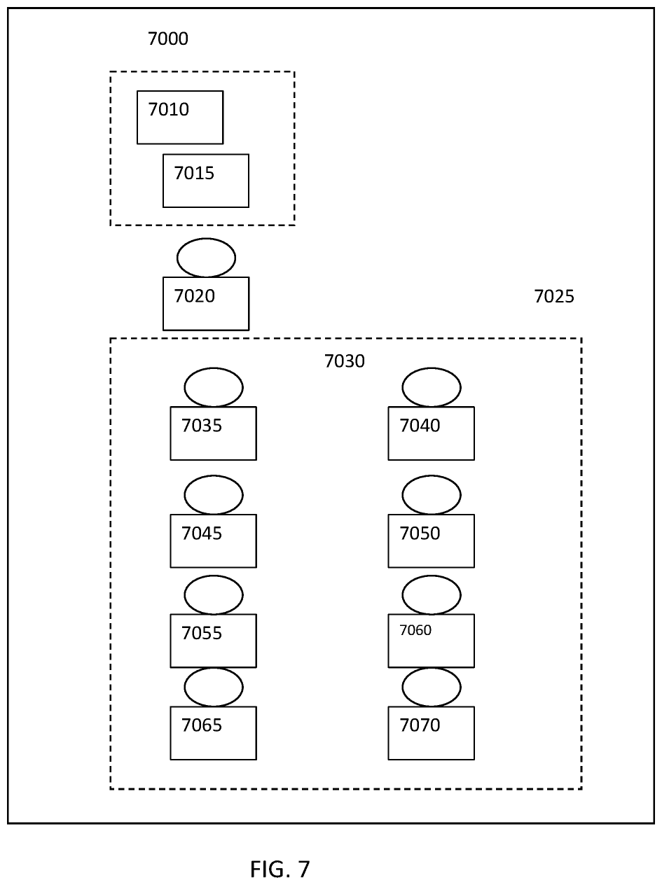

Referring to FIG. 7 which shows the Digital Ledger Technology (DLT) infrastructure 7000 of the instant invention. Each transaction involves multiple parties. Each party has only visibility over the transactions they are involved in. The process is started by the Requester, that wants to verify if the Insured has enough insurance coverage to meet its requirements. The Requester is a user of a DPOIS, such as the instant invention Platform. The service tier 7010 is where the API server 7015 resides. API server communicates with the notary 7020 and Business Network Operator 7025. The various parties involved with the transaction are grouped under roles 7030 and include Requesters 7035 and 7040, Policyholders 7045 and 7050, Producers 7055 and 7060, Carriers 7065 and 7070.

Distributed Ledger Technology (DLT) is an umbrella term used to describe technologies which store, distribute and facilitate the exchange of value between users, either privately or publicly. DLT is a digitalized and decentralized logbook of record. More simply DLT is a decentralized database that is managed by various participants. There is no central authority that acts as arbitrator or monitor. As a distributed log of records, there is greater transparency, making fraud and manipulation more difficult, and it is more complicated to hack the system.

The process is started by the Requester, that wants to verify if the Insured has enough insurance coverage to meet its requirements. The Requester is a user of a DPOIS of the instant invention.

Workflow A: Creation of a Proof of Insurance Request.

The Requester logs in the DPOIS and identifies the Insured.

The DPOIS system connects to the instant invention IVN to resolve the identities of the parties involved in the transaction.

The Requester associates a set of insurance requirements to the Insured.

The Requester creates a Proof of Insurance Request that the DPOIS will send to the Insured.

The DPOIS connects to the Requester node and proposes a transaction between the Requester and the Insured. This transaction contains details such as the requirements that the Insured must meet to satisfy the request, and a timeframe that specifies how long the Requester wants to receive updates on the policy (See below). This is transaction TA1.

Workflow B: forwarding of the Proof of Insurance Request

The Insured is notified by their DPOIS. If the Insured does not yet use a DPOIS, an unconfirmed organization will be created on the DPOIS used by the Requester.

The Insured lands on the DPOIS and sees a page that details the insurance requirements, the Request Landing Page.

On the Request Landing Page, the Insured can forward the request to the Producer by clicking on the “Forward Request” button.

Once the button is clicked, the Insured is prompted to identify the Producer.

The DPOIS system connects to the embodiment of the invention IVN and resolves the identity of the Producer.

The DPOIS system proposes a transaction that updates TA1 adding the identity of the Producer to it. This transaction is now visible on the Producer node and becomes TA2.

Workflow C: creating a Distributed Proof of Insurance (DPOI)

The Producer logs in their DPOIS. If the Insured does not yet use a DPOIS, an unconfirmed organization will be created on the DPOIS used by the Requester.

The Producer visualizes the Proof of Insurance Request.

If the Producer node has access to digitized insurance policies on the distributed ledger, and the Insured has a policy that matches the requested type, the DPOIS system will match and compare the policy attributes with the requirements from the Proof of Insurance Request thereby preventing fraud.

The Producer eventually confirms/provides additional information to complete the request.

Once the Producer is ready, they create a Distributed Proof of Insurance by finalizing the Proof of Insurance Request. This is a new transaction that references both TA2 and the digitized insurance policy and adds the Carrier as an additional party. We will call this transaction TB1.

With this transaction, all the parties share the same DPOIS and will receive updates when this object is updated by the Carrier—for example, when the underlying policy enters in pending termination state, the Producer will be able to visualize this change and reach out to the Insured.

Workflow D: receiving updates on DPOI events.

Since the DPOI is a shared object between all the participants, any update is immediately visible to all participants to the transaction.

The Requester will be notified as soon as the policy is terminated within the specified timeframe.

If the Insured decides so, they can stop the propagation of updates to the Requester (e.g. they are not doing business anymore).

The Broker will be able to update the DPOI previously provided to Requesters by matching a new coverage purchased by the insured.

The Requester will be notified if the coverage is reinstated.

Method Overview.

As shown in FIG. 4 a method for forming, storing, managing, and executing COIs using Distributed ledger technology/distributed ledger (BDL) integrations can include integrations with one or more distributed ledger systems, distributed ledger technology systems, and/or other suitable mechanisms for consensus of replicated, shared, and synchronized data. BDL integrations may be used for data output and/or input. A programmable clause could generate an output that is transacted on, or performs a transaction on, a BDL. The programmable clause could alternatively read data from a BDL as a data input. In addition to supporting BDL input and output, the BDL integrations can support multiple types of BDL simultaneously from one COI. As an example of having multiple integrations, information retrievable through a BDL system can be monitored, and based on information of the BDL system, execution of the logic of a programmable clause can direct updating an external API endpoint based on the BDL system. In this way, BDL functionality used in combination with a computable contract can also be used to drive other external platform integrations, which may not be readily feasible in other consensus based BDL systems.

The execution environment functions to manage the processing of the COI during formation and/or post-formation. The execution environment may be a decentralized execution environment so as to distribute trust from a single entity. A decentralized variation of the execution environment can be a peer-to-peer network. The contract logic, state and/or updates to the contract draft can be maintained through the decentralized network. The execution environment may alternatively use a centralized variation of the decentralized execution environment.

All involved parties may utilize a standardized execution environment which may include but is not limited to: a virtual machine, communicatively connected servers/virtual machines, BDL system(s), a centralized server, cloud environment, container or series of containers, computing cluster, or any other appropriate execution environment or combination thereof. In one embodiment, the execution environment consists of a peer-to-peer network (an overlay network on top of the World Wide Web and the system of the invention where each user (e.g. a contracting party) that uses the system and method is a node on the network. Multiple users may concurrently use the system and method across a plurality of COIs concurrently. Other node types and server nodes, as stated herein, may also be used in embodiments.

In connection with the execution environment, the execution environment can include a state transitioning engine that functions to establish a consensus of updates to the COI and resolve conflicts. The State Transitioning Engine may provide a basis for a secure Conflict-Free Replicated Data Type (CRDT) structure, which can enable the COI to be replicated data across multiple computers in a network (e.g. locally or on a public network such as the internet); thereby facilitating distributed/peer-to-peer state sharing of COIs and data pertaining to contract performance and execution. The State Transitioning Engine may be updated either by: (a) the user signing the state update or (b) such updates being automated or substantially automated either by the State Transitioning Engine and/or the logic of the contract.

Areas of Applications

The system and method may be applied in various ways and for different applications, which may provide a number of potential benefits. One potential benefit is that the execution, operation, history, and performance of a contract can be tracked and immutably stored throughout the contract lifecycle. A state update mechanism enables updates to the state of the contract (and, depending on the implementation, associated systems, documentation, and others) to be automated by data external to the contract (e.g. from edge computing devices, IoT platforms, APIs, databases, BDLs, etc.

Another potential benefit is that the system and method provide a common underlying data structure for COIs that are versioned, auditable, and searchable. In some variations using Merkle links, the data structure can also be cryptographically immutable. This enables the contractual lifecycle to be entirely cryptographically secure--throughout negotiation to execution, performance, and completion/termination. One potential benefit is that the underlying data structure enables legal COIs and other documents to be securely and verifiably linked together. For example, COIs can be integrated with other COIs using the system and method through common object references or otherwise. This may facilitate inter-contract references at the formation stage as the invention as consistency and real-time updates between the invention and COIs (and/or other documentation that may use the system and method) at the post-formation stage. Similarly, the data structure may integrate with BDLs to the same qualities. The data structure may also be used to extend beyond the contract to manage workflows or other events that may pertain to the contract such as interfacing with an IoT device or platform, an API, or other external data resources and systems.

Another potential benefit is that this data structure and execution environment enables legal COIs to be formed and executed in a peer-to-peer manner using the graph data structure as a versioning, record, and/or storage mechanism. The system and method may utilize a contract document representation that decomposes elements of a contract to object components that can be efficiently updated and/or processed through a peer-to-peer execution environment. Using a decentralized or distributed execution environment (such as a peer-to-peer network execution environment) enables parties to execute and store a contract without reliance upon a single controlling entity that may act as a point of failure. A single point of failure is potentially a crucial issue to overcome where COIs are computable, and data driven. Furthermore, the MDAG (MDAG refers to Minimalistic Directed Acyclic Graph which is a Java library capable of constructing character-sequence-storing, directed acyclic graphs of minimal size) structure ensures that changes to the COI code, events, and operations in the execution of the contract, and the record of its current and historical state cannot be altered, modified or tampered with in an unverifiable/authorized manner without this being noticeable. Even where a peer-to-peer network or other distributed or decentralized execution environment is not used (e.g. a centralized server or wholly cloud-based implementation), the MDAG variation may have the benefit of reducing trust issues in the same.

The system and method may also provide a number of benefits when used with BDL technologies in legal COIs. First, COIs may have native ‘off-chain’ cryptographic and state transitioning functionalities (i.e. of the contract itself and/or its formation and post-formation state) and may only need to interact with BDLs if, where, and when required, such as to perform ‘on-chain’/‘on-ledger’ transactions, share state, share data/objects, use as a consensus mechanism, and the like. Such BDL integrations can be used when desired or beneficial to the contract and/or as part of a wider exercise/execution of a contractual agreement. In other words, COIs may be seen as hybrid ‘on-chain’/‘off-chain’ COIs. Consequently, for legal COIs that may use “smart contract” scripts, BDLs integrations of the system and method may be more computationally efficient, scalable, and any privacy concerns of the use of “smart contract scripts” may be reduced or alleviated. Using a BDL independent data structure and protocol provides flexibility for the COIs. COIs may also be more flexible and dynamic as execution computation can be performed ‘off-chain’/‘off-ledger’ that may not be possible ‘on-chain’/‘on-ledger’ and interact with multiple chains of the same or different protocols. Additionally, the code or logic of contract may be easier to amend where necessary. A computable contract managed and executed through the system and method can offer contracting parties the ability and option to not use a BDL(s) where, for example, it is not necessary for execution of the contract or if they elect not to. Where the parties do elect to use a BDL, the parties may elect the most suitable underlying protocol or protocols (e.g. if a COI is executed on, or otherwise uses, multiple different BDLs) for a given COI relationship. Additionally, multiple different types of BDLs may be used during execution of the same COI. In a variation utilizing an MDAG variation of the COI, the system and method can additionally enable them to interface with a BDL while maintaining a cryptographically secure relationship between the instant invention input and output data, state changes, as the invention as integrations with BDLs on:
1. an ‘input’ basis (i.e. drawing data into the data structure from BDLs) and
2. ii) on an ‘output’ basis for specific external BDL-based architectures (e.g. where the BDL is used for computation of the contract logic such as through the use of “smart contract” scripts, as stated herein).
   Second, depending on the protocol, ‘on-chain’/‘on-ledger, other “smart contract” scripts on BDLs may suffer from a lack of concurrency as each transaction may require a global lock on the database associated with a “smart contract,” and transactions may have to be totally ordered. In the system and method, the use of the data structure can have transitions partially ordered. Third, every participant/node on the BDL does not need to run or access all code and/or reach consensus as to the state of an entire BDL or entire state machine. By contrast, only the parties to the contract (or any other party so required) need to sign state updates (unless the use of a consensus mechanism is required). A similar situation pertains to any inputs and outputs. Regarding inputs, external data does not necessarily have to be included in the chain/ledger to achieve consensus—this may, among others, improve privacy, increase speed, reduce chain/ledger bloating, and assist in creating more granular and dynamic COIs. Regarding outputs, multiple nodes would have to interact with an external resource (resulting in multiple calls and possibly multiple sets of returned data which may or may not be consistent) or one node would have to do so—therefore requiring parties to trust that particular node. Fourth, states are cryptographically signed off, validated, transmitted, or shared between the parties and any authorized third parties without public computation or sharing with any third parties (unless otherwise required). Fifth, it gives flexibility in the use of any underlying BDL protocol based upon the needs of a given contract, rather than potentially tying execution to one protocol or even one embodiment of a ledger of the instant invention. One or more BDLs of the same or differing protocols may be used in a given contract. This is in contrast to existing systems where the machine-readable contract data structure exists on the BDL. A related potential benefit is that the contract may, in this respect, add a form of interoperability between BDLs from a COI. Sixth, COI computation may be separated from transaction logic so that the BDL may execute non-contractual logic, rather than the logic of the contract per se (e.g. via standardized ‘on-chain’/‘on-ledger’ scripts that perform set functions/operations on the BDL). This has the benefit of reducing ledger and code complexity, as well as improving privacy and performance as logic and data may be kept between the parties and only exposed to the ledger/chain when necessary or beneficial to do so. Only exposing parts of the graph data structure (e.g. certain objects) to ‘on-chain’/‘on-ledger’ code also assists in this regard. Seventh, the underlying graph data structure may enable an end-to-end cryptographic environment in an MDAG variation of the system and method. A cryptographically immutable and verifiable flow in the contract and transaction management lifecycle through contract formation, execution, transactions (particularly where a BDL system is used) and analytics. For example, where a computable contract interacts with a distributed ledger, objects in the graph may be used to execute and/or be referenced in ‘on-chain’ transactions or records (e.g. by their hash, identifiers, metadata, etc.), calling code on an ‘on-chain’/‘on-ledger’ library (or similar) similar to that defined in U.S. patent application Ser. No. 15/476,791, or passed to ‘on-chain’/‘on-ledger’ code. This may have the additional benefit of enabling dynamism in the contract state itself and only passing data to ‘on-chain’/‘on-ledger’ code or otherwise executing on-chain’ (e.g. by compilation, calling ‘on-chain’/‘on-ledger’ code, etc.) as and when required. In one such view, the graph data structure may be seen as a cryptographically secure ‘contract oracle’ that provides contractual state to ‘on-chain’/‘on-ledger’ code. In one variation, an ‘on-chain’/‘on-ledger’ rules engine or library such as the one described in U.S. patent Ser. No. 15/476,791 may be used to store on-chain code, which may be called, deployed, or initiated using Cal objects/data as mentioned herein. Eighth, as COIs do not have to be executed ‘on-chain’, there is a potential benefit that parties themselves may not have to be ‘on-chain’ nodes/participants to be users of the system and method and/or the contract code to be used, deployed or otherwise exposed on a given BDL. This is particularly beneficial where a party to the contract may not be needed to be a participant/node of a given BDL or other system. For example, a BDL for logistics may integrate with the contract (e.g. in the manners presented herein) without the contracting parties being participants/nodes. Ninth, the system and method may enable contract state/transitions to be ‘undone’ or ‘rolled back’ to a previous state by traversing the COI data structure. Transactions that occur on a BDL typically cannot themselves be reversed except where a new transaction is initiated to perform this function depending upon the specification of the protocol. This obviously creates further issues in that the mere exposure of that data to participants of the BDL, cannot be reversed, and relies upon other parties agreeing to the reversal. The system and method may avoid or otherwise mitigate these issues. Finally, an implementation of the graph data structure may store more granular data and metadata about the state of a contract than a BDL could, could do in an economically viable manner, or that the parties would want to store ‘on-chain’. All state transitions may be stored, and this may be used in the contract logic and/or ‘on-chain’/‘ion-ledger’ “smart contract” code. For example, states that are not transactions or state changes that require a ledger, but are necessary to store to give a verifiable history or to compute the logic of the contract effectively (e.g. dynamic state calculations, computation of state such as compounding calculations, logic that requires recalling of prior states, etc.).

A related potential benefit is that an MDAG variation of the system and method supports objects that are Conflict-free Replicated Data Types (CRDTs). CRDTs may be beneficial to replicate data across peers in a network to achieve eventual consistency, such as in the peer-to-peer network execution environment stated herein. Where commutative replicated data types (CmRDTs) are used, this may operate in a manner similar to state machine replication used in BDL systems. A potential benefit of doing so is that the state of a contract may be replicated across peers in a manner that may, for example, be limited by state machine replication in a BDL system (e.g. by performance constraints).

Yet another potential benefit is that as legal COIs can be entities that are natively formed on a peer-to-peer basis between parties and are used to govern the relationship between those parties, the system and method may enable legal COIs to be formed and executed between the involved parties on a natively peer-to-peer basis, rather than using a centralized system or intermediary. The system and method--when used with a peer-to-peer networking protocol/execution environment or similar--removes a single point of failure; and reduces the trust that necessarily needs to be placed in a central entity to ensure that the contract, its state, history and the integrity of other data pertaining to the contract. By decentralizing and/or distributing the storage and execution of the contract between the parties, an MDAG variation may make it possible to provably ensure the integrity of the COI data whilst accessing obtains the benefits of accessing and managing it in a centralized manner.

A further potential benefit is that the graph data structure may be queried, or data may be otherwise extracted (e.g. when used in conjunction with a contract management system) to provide data and the base for descriptive, predictive, prescriptive, and any other appropriate form of analytics across pre-and post-execution of one or more COIs.

The object ledger structure may also include data from other distributed ledgers (e.g. transaction and other data pertaining to transactions/operations performed on other BDLs, IoT data for input to the contract, and other data stored on BDLs, Digital Ledger Technology, database, stack and systems/applications, etc.).

Any appropriate combination of data may be stored in each record (or block, where a ‘distributed ledger technology’ ledger structure is used). Where a ‘distributed ledger technology’ (or other applicable ledger) is used, the data may be stored in the state database or in any other appropriate form.

Implementations depicting exemplary data that may include a contract root, a contract UUID, a clause UUID, an update UUID, a clause reference, change data, and/or a transaction ID. A universally unique identifier (UUID) is a 128-bit number used to identify information in computer systems. A contract root may be a hash of the contract root (i.e. its current cryptographic state) such as before and after the update from the graph data structure. A Contract_UUID may be a UUID/identifier of the contract. A clause_UUID may be the UUID of the clause(s) to which the update relates (and any associated metadata relating to the clause). Any references that may change (e.g. clause_UUID) may be stored prior to and after the update. An update_UUID may be the state update identifier (and associated metadata) from the graph data structure. A clause reference may be the reference of the clause. Change data can include object(s) from the graph data structure or other data that represents the new state of the object and (where, in an appropriate embodiment) any associated metadata. A transaction_ID may be a transaction identifier and other metadata for a transaction or (series of transactions) performed on a BDL in the methods stated herein (e.g. compilation to on-chain/on-ledger VM bytecode, deploying/invoking ‘on-chain’/‘on-ledger’ code, passing objects to on-chain code, etc.) relating to the state update.

Additional and/or alternative data/types may be used. In an alternative embodiment, the graph data structure may be replaced with another storage medium/mechanism and the data exposed on the object ledger. Records may be linked with the hash of the previous record ‘header’ (e.g. ‘Record 1’, ‘Record 2’, ‘Record n’, etc., depending on the identifier used) on the ledger.

Transactions may be performed on other distributed ledgers where the nodes/participants include those other contracting parties and those related to the contract. Those BDLs may be authorized/private or non-authorized/public, and may use any appropriate underlying protocol (e.g. Hyperledger Fabric, Ethereum, Chain, etc.). The data pertaining to the transaction on this BDL may be reflected in the same record on the object ledger structure, as depicted in FIG. 7 (e.g. if the record pertains to such a transaction then the record may be left open and then added when the transaction is initiated, executed, or other such data is available to include in the record/block). An alternative embodiment where the transaction is recorded as a separate record in the ledger from the contract. Any appropriate data may be added to the record, including a link to the record to which the transaction relates. Alternatively, the data may be repeated in the block/record that includes the transaction data. The transaction block/record may be linked by a hash (as above) to the previous record/block in the object ledger structure, or may be linked by the record/block reference to which the transaction relates (e.g. instead of ‘Record 4’ being linked to ‘Record 3’, the former may, alternatively or additionally, be linked to ‘Record 2’ which stores the related data from the graph data structure).

The systems and methods of the embodiments can be embodied and/or implemented at least in part as a machine configured to receive a computer-readable medium storing computer-readable instruction. The instructions can be executed by computer-executable components integrated with the application, applet, host, server, network, the website, communication service, communication interface, hardware/firmware/software elements of a user computer or mobile device, wristband, smartphone, or any suitable combination thereof. Other systems and methods of the embodiment can be embodied and/or implemented at least in part as a machine configured to receive a computer-readable medium storing computer-readable instruction. The instructions can be executed by computer-executable components integrated with apparatuses and networks of the type described above. The computer-readable medium can be stored on any suitable computer-readable media such as RAMs, ROMs, flash memory, EEPROMs, optical devices (CD or DVD), hard drives, floppy drives, or any suitable device. The computer-executable component can be a processor, but any suitable dedicated hardware device can (alternatively or additionally) execute the instructions.

FIG. 8 provides a basic compliance module dashboard overview 8000 which shows the compliance percentages 8080, compliance trends 8090 and document verification 8100. It also highlights parties with issues 8200, non-compliant 8210, expiring 8220 and non-responsive problems 8230.

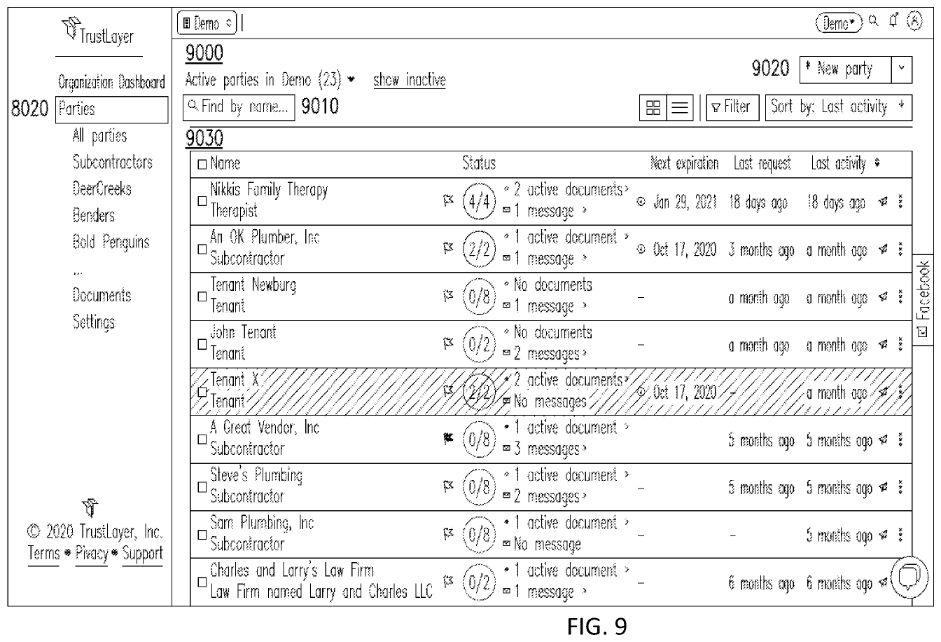

FIG. 9 provides the compliance module active party dashboard 9000 which shows the active parties in the transaction 9030.

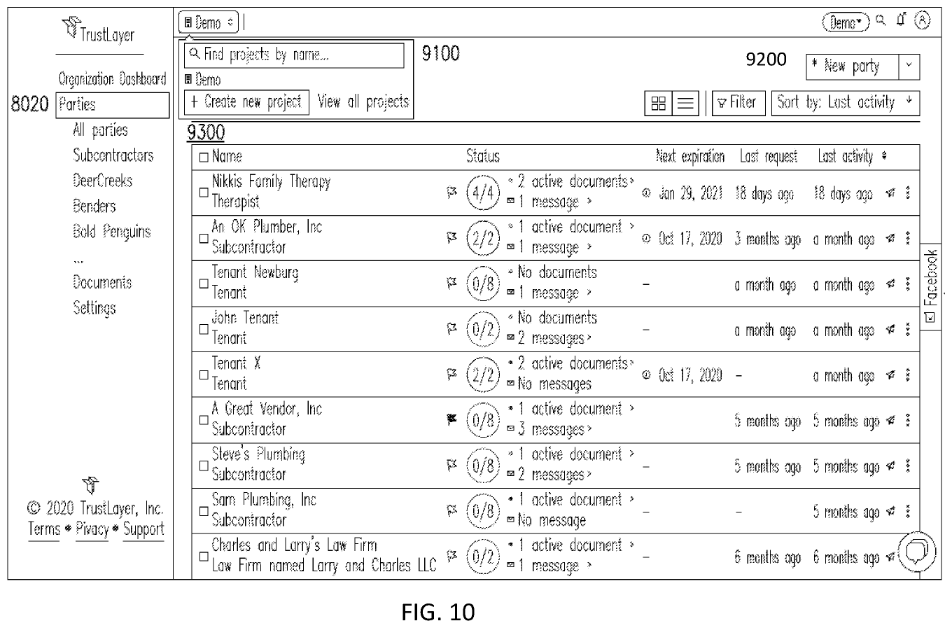

FIG. 10 provides the compliance module organization parties dashboard 9100 which shows the parties 9300.

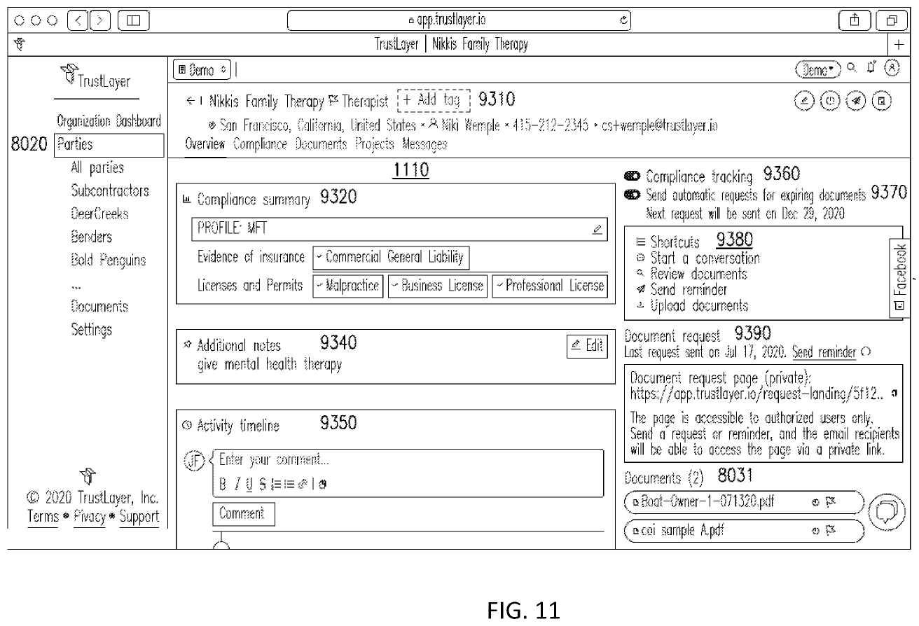

FIG. 11 provides the compliance module detail dashboard 1110. It provides compliance summary 9320, additional notes 9340 and activity time line 9350.

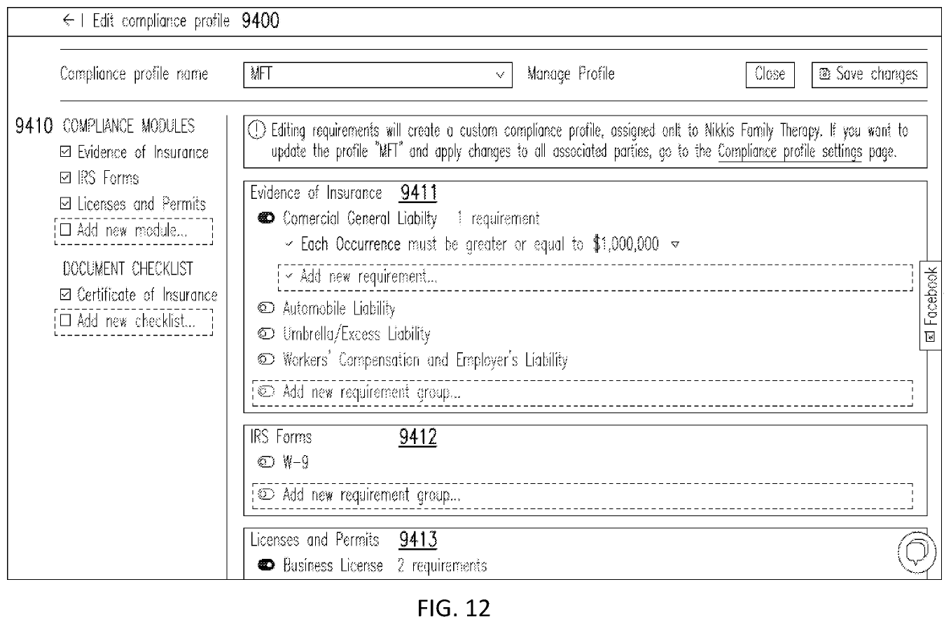

FIG. 12 provides the compliance module evidence of insurance dashboard 9400. It provides evidence of insurance 9411, IRS forms 9412 and Licenses and permits 9413.

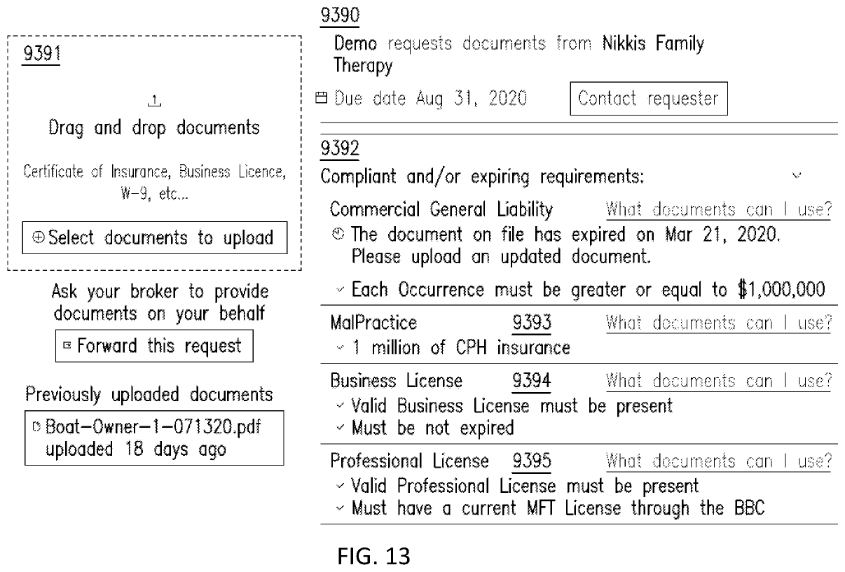

FIG. 13 provides the compliance module compliant and expiring requirements form 9390. It provides a method of attaching documents 9391, compliant and expiring requirement information 9392, a malpractice field 9393, a business license field 9394 and professional license field 9395.

As a person skilled in the art will recognize from the previous detailed description and from the figures and claims, modifications and changes can be made to the embodiments of the invention without departing from the spirit and scope of this invention as defined in the following claims.

Alternatively, the system can be integrated or utilized as an application for Salesforce, CRMs, QuickBooks, ERP systems, Vendor Management system, and additional 3rd party systems and it could be incorporated into Insurance Commissioners (i.e. Regulators) systems.

To those skilled in the art to which this invention relates, many changes in construction and widely differing embodiments and applications of the invention will suggest themselves without departing from the scope of the invention as defined herein. The disclosures and the descriptions herein are purely illustrative and are not intended to be in any sense limiting.

1. A method of collecting and displaying certificate of insurance data comprising of a certificate of insurance management system accessible by the involved parties, managing document data comprising of obtaining object components of the certificate of insurance document, assembling the certificate of insurance and storing it for distribution to the appropriate entities using data structure.

2. The certificate of insurance data of claim 1 wherein the data is selected from the group consisting of first name, last name, email, role, department, organization, address, country, region, city and zip code.

3. The data structures of claim 1 wherein the data structures are selected from a Digital Ledger Technology, database and stack.

4. The parties of claim 1 wherein the parties are selected from the group consisting of customer, insurance company, contracting company, insured, clients and certificate holder or counterparty.

5. A method of collecting and displaying certificate of insurance data comprising of a certificate of insurance management system accessible by the involved parties, managing document data comprising of obtaining object components of the certificate of insurance document, assembling the certificate of insurance and storing it for distribution using distributed ledger technology.

6. The distributed ledger technology of claim 5 wherein the data is stored in a distributed ledger technology selected from the group consisting of Hyperledger Fabric and Ethereum Chain.

7. The certificate of insurance of claim 5 wherein the certificate of insurance is stored in a MDAG variation format.

8. The certificate of insurance MDAG variation format of claim 7 wherein the MDAG variation format is a cryptographically secure relationship between the input and output data and state changes, with distributed ledger technology storage.

9. The certificate of insurance MDAG variation format of claim 8 wherein the MDAG variation format has an input basis and an output basis.

10. A method of collecting and displaying certificate of insurance data in real time comprising of a certificate of insurance management system accessible by the involved parties, managing document data comprising of obtaining object components of the certificate of insurance document, assembling the certificate of insurance and storing it for distribution to the appropriate entities using data structure and said parties having access to said certificate of insurance document data at the time of entry.

11. The certificate of insurance data of claim 10 wherein the document data is selected from the group consisting of first name, last name, email, role, department, organization, address, country, region, city and zip code.

12. The data structures of claim 10 wherein the data structures are selected from a Digital Ledger Technology, database and stack.

13. The parties of claim 10 wherein the parties are selected from the group consisting of customer, insurance company, contracting company, insured, clients and certificate holder or counterparty.

14. A method of verifying certificate of insurance data in real time comprising of a certificate of insurance management system accessible by the involved parties, managing document data comprising of obtaining object components of the certificate of insurance document, assembling the certificate of insurance and storing it for distribution to the appropriate entities using a data structure and said parties having access to said certificate of insurance document data at the time of entry and said parties comparing said data to said requirements to identify fraud.

15. The certificate of insurance data of claim 14 wherein the document data is selected from the group consisting of first name, last name, email, role, department, organization, address, country, region, city and zip code.

16. The data structures of claim 14 wherein the data structures are selected from a Digital Ledger Technology, database and stack.

17. The parties of claim 14 wherein the parties are selected from the group consisting of customer, insurance company, contracting company, insured, clients and certificate holder or counterparty.

18. A method of verifying certificate of insurance data in real time system comprising of a certificate of insurance management system accessible by the involved parties, managing document data comprising of obtaining object components of the certificate of insurance document, assembling the certificate of insurance and storing it for distribution to the appropriate entities using a data structure and said parties having access to said certificate of insurance document data at the time of entry and said parties and said system comparing said data to said requirements to manage risk.

19. The certificate of insurance data of claim 18 wherein the document data is selected from the group consisting of first name, last name, email, role, department, organization, address, country, region, city, and zip code.

20. The data structures of claim 18 wherein the data structures are selected from a Digital Ledger Technology, database, and stack.

21. The parties of claim 18 wherein the parties are selected from the group consisting of customer, insurance company, contracting company, insured, clients and certificate holder or counterparty.

22. The real time system of claim 18 wherein the said real time system compares said data using a Natural Language Processing module.

23. The Natural Language Processing module of claim 22 uses Machine Learning to find and identify information in a document.
